(19) United States
(12) Patent Application Publication
(10) Pub. No.: US 2026/0342717 A1
(43) Pub. Date: Oct. 29, 2026

(54) EQUAL-COST MULTI-PATH (ECMP) OPERATIONS

(71) Applicant: Mellanox Technologies, Ltd., Yokneam (IL)

(72) Inventors: Chen Rozenbaum, Beer Yakov (IL); Quentin Barrand, Zürich (CH)

(21) Appl. No.: 19/191,594

(22) Filed: Apr. 28, 2025

(51) Int. Cl. H04L 45/24; H04L 45/02; H04L 45/28; H04L 45/745

(52) U.S. Cl. CPC H04L 45/24; H04L 45/02; H04L 45/28; H04L 45/745

(57) ABSTRACT

Technologies for optimizing Equal-Cost Multi-Path (ECMP) using a network pipeline abstraction layer (NPAL) are described. One DPU can provide a virtual bridge and an NPAL that provides a network pipeline. The virtual bridge can asynchronously receive, from a first thread of the NPAL, one or more create requests to create an ECMP group. The virtual bridge can asynchronously create the respective ECMP group in response to each of the one or more create requests. The virtual bridge can receive, from a second thread of the NPAL, a first request for acknowledgement for the create requests. The virtual bridge can determine that each of the one or more ECMP groups has been successfully created, and send, to the second thread, a first acknowledgement in response to the first request for acknowledgement, the first acknowledgement indicating the one or more ECMP groups have been successfully created in the virtual bridge.

### TECHNICAL FIELD

At least one embodiment pertains to processing resources used to perform and facilitate operations for providing network pipeline abstraction layer (NPAL) Equal-Cost Multi-Path (ECMP) operations. For example, at least one embodiment pertains to processors or computing systems used to provide and enable ECMP operations by an acceleration hardware engine to process network traffic data in an accelerated data plane, according to various novel techniques described herein.

### BACKGROUND

In traditional network architectures, specialized hardware devices known as middleboxes manage various security and performance functions. Firewalls, standalone physical appliances positioned at the network's edge, scrutinized incoming and outgoing traffic according to set rules, thereby safeguarding the internal network from external threats. Load balancers, as separate hardware units, intelligently distributed incoming network and application traffic across multiple servers to prevent overload and ensure efficient resource utilization, thus enhancing application availability and performance. Intrusion Detection Systems (IDS), strategically located within the network, monitored and analyzed network traffic for signs of anomalies, attacks, or security policy violations, effectively identifying potential security breaches.

Additionally, networks utilized other middlebox functions such as Data Loss Prevention (DLP) systems to monitor and prevent unauthorized data exfiltration, virtual private network (VPN) Gateways to establish secure and encrypted connections across networks, and Wide Area Network (WAN) Optimization appliances designed to improve data transfer efficiency across wide area networks. Although essential, these middleboxes presented challenges: they required significant capital investment, occupied valuable space in data centers, and demanded specialized personnel for operation and maintenance. Scaling these network functions often meant acquiring and integrating more physical devices, which added to the complexity and cost of the network infrastructure.

### BRIEF DESCRIPTION OF DRAWINGS

Various embodiments in accordance with the present disclosure will be described with reference to the drawings, in which:

FIG. 1 is a block diagram of an integrated circuit with Equal-Cost Multi-Path (ECMP) logic for ECMP optimizations according to at least one embodiment.

FIG. 2 is a block diagram of an example computing system with a data processing unit (DPU) having a network pipeline abstraction layer (NPAL) with ECMP optimizations in an optimized and accelerated network pipeline to be accelerated by an acceleration hardware engine according to at least one embodiment.

FIG. 3 is a block diagram of a software stack of a DPU with an NPAL with ECMP optimizations according to at least one embodiment.

FIG. 4 is a sequence diagram of an ECMP group creation operation in a synchronous mode according to at least one embodiment.

FIG. 5 is a sequence diagram of an ECMP group creation operation in an asynchronous mode according to at least one embodiment.

FIG. 6 is a network diagram of an example network pipeline that is optimized and accelerated on an acceleration hardware engine of a DPU having an NPAL with ECMP optimization according to at least one embodiment.

FIG. 7 are flow diagrams of Equal-Cost Multi-Path (ECMP) operations before a link failure, after a link failure, and after a link recovery according to at least one embodiment.

FIG. 8 is a network diagram of an example network pipeline that is optimized and accelerated on an acceleration hardware engine of a DPU having an NPAL according to at least one embodiment.

FIG. 9 is a network diagram of an example network pipeline that is optimized and accelerated on an acceleration hardware engine of a DPU having an NPAL according to at least one embodiment.

FIG. 10 is a flow diagram of a method of operating a DPU with ECMP optimization according to at least one embodiment.

FIG. 11 is a block diagram of a computing system having two processing devices coupled to each other and multiple networks according to at least one embodiment.

FIG. 12 is a block diagram of a computing system having a central processing unit (CPU) and a graphics processing unit (GPU) in a single integrated circuit according to at least one embodiment.

FIG. 13 is a block diagram of a computing system having tensor core graphics processing units (GPUs) according to at least one embodiment.

### DETAILED DESCRIPTION

Technologies for optimizing Equal-Cost Multi-Path (ECMP) using a network pipeline abstraction layer (NPAL) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, in traditional network architectures, various security and performance functions were managed by specialized hardware devices known as middleboxes (e.g., firewalls, load balancers, IDSs, etc.). Traditional networks were designed with the assumption that all resources would be housed within an on-premises data center, and often characterized by a centralized model.

Modern networks are increasingly cloud-centric, designed to support cloud services and applications. This includes the use of public, private, and hybrid cloud infrastructures, requiring networks to be more flexible and scalable. Unlike traditional network architectures that rely heavily on physical hardware (i.e., each network function requires its own dedicated device), current network architectures leverage virtualization technologies, such as software-defined networking (SDN) and network function virtualization (NFV). These allow network resources to be abstracted from hardware, providing greater flexibility, easier management, and reduced costs. Modern networks increasingly use automation and orchestration tools to manage network resources efficiently, reduce operational overhead, and enable faster deployment of network services. Modern networks are designed for scalability and high performance, utilizing technologies like edge computing to process data closer to the source and reduce latency. Current network architectures are more flexible, scalable, and efficient than traditional ones, designed to support the dynamic and distributed nature of modern computing resources and work practices. They integrate advanced technologies like cloud services, virtualization, and automation to meet the demands of today's digital environment.

Aspects and embodiments of the present disclosure can provide a virtual bridge and a NPAL with ECMP optimizations for creating and deleting ECMP groups. The NPAL is a software programmable layer, to provide an optimized network pipeline that supports different accelerated network capabilities, such as Layer-2 (L2) bridging, Layer-3 (L3) routing, tunnel encapsulation, tunnel decapsulation, hash calculations, Equal-Cost Multi-Path (ECMP) operations, static and dynamic Access Control Lists (ACLs), Connection Tracking (CT), Quality of Service (QoS) rule, Spanning Tree Protocol (STP), virtual local area network (VLAN) mapping, network address translations (NATs), software-defined networking (SDN), multi-protocol label switching (MPLS), etc. That is, the NPAL is an accelerated programmable network pipeline to provide an abstraction of the underlying functionality of a network pipeline that is optimized for hardware acceleration on the hardware. The NPAL can be, or similar to, a database abstraction layer (DAL). DAL is a programming concept used in software engineering to provide an abstraction over the underlying database systems, allowing applications to interact with different databases, low-level software layers or hardware directly without needing to change the application code. The DAL typically includes a set of applications programming interfaces (APIs) or classes that provide a unified interface for performing common database operations, such as querying, inserting, updating, and deleting data. By using the DAL, developers can write database-independent code, reducing the coupling between the application and the specific database implementation. Similarly, the NPAL can include a set of APIs or classes that provide a unified interface for performing common networking operations in a network pipeline that is optimized for hardware acceleration on the hardware. In particular, the NPAL can provide a unified interface to one or more applications, network services, or the like, executed by the integrated circuit or a host device. NPAL can provide an optimized network pipeline that supports multiple network protocols and functionalities. The network pipeline can include a set of tables and logic in a specific order, the network pipeline being optimized to be accelerated by the hardware, providing customers and users a rich set of capabilities and high performance.

Using an NPAL can provide various benefits, including operational independence, encapsulation of logic, performance, code reusability, platform independence, or the like. For example, developers can write agnostic code, allowing applications (e.g., network services) to work with different underlying access logic and network functionality. The NPAL can encapsulate the access or network function-related logic, making it easier to manage and maintain the codebase. systems. Changes to the schema or underlying technology can be isolated within the NPAL implementation. The NPAL can provide an optimized and high-performance pipeline to address different networking requirements and functionality. By separating access logic from application logic, developers can reuse the NPAL components across multiple parts of the application (network service), promoting code reuse and maintainability. The NPAL can abstract away platform-specific differences, data types, and other access or network function-related features, enabling the application (network service) to run on different platforms and environments seamlessly. Overall, the NPAL can be a powerful tool for building flexible, scalable, and maintainable network function-driven applications, offering a level of abstraction that simplifies interactions between network functions and promotes code efficiency and portability.

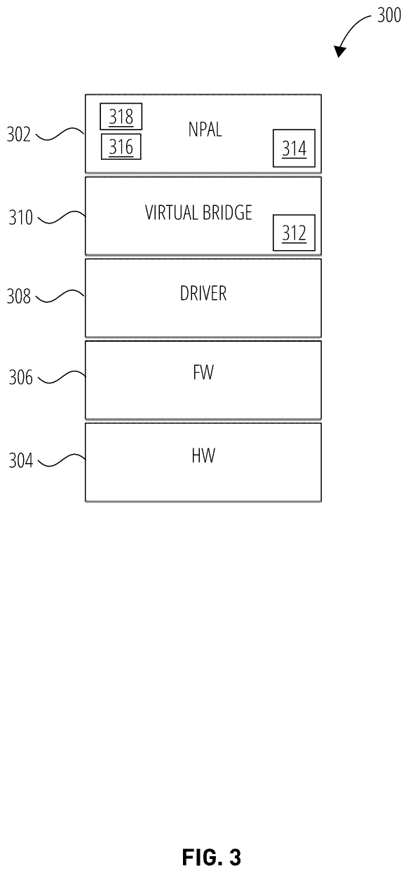

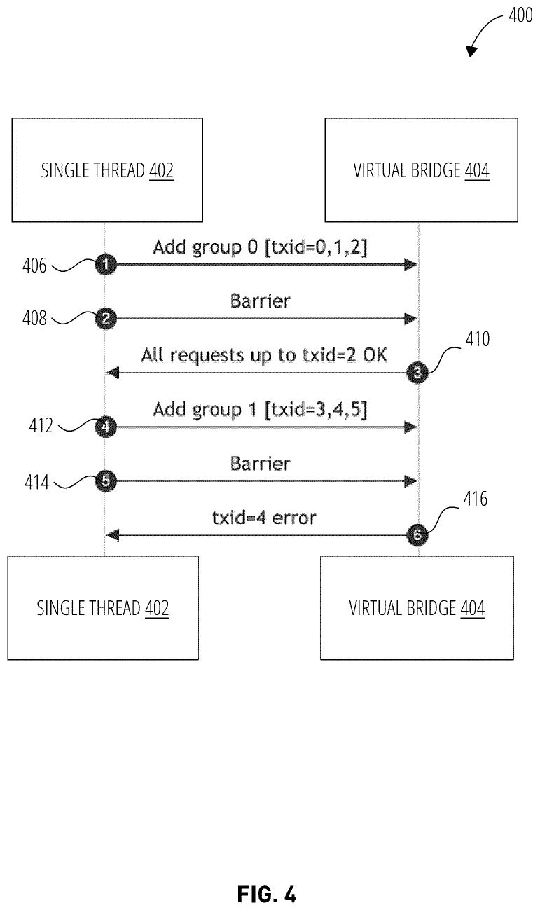

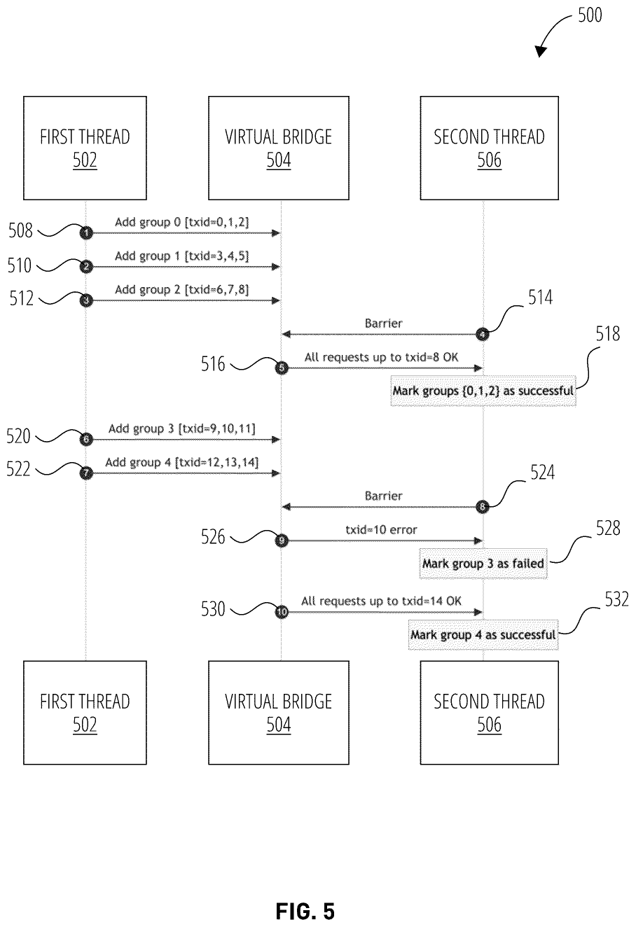

As described herein, aspects and embodiments of the present disclosure can provide a NPAL that provides ECMP optimizations for creating and deleting ECMP groups. ECMP is a routing strategy that allows multiple next-hop paths to be used for forwarding traffic when multiple paths have the same cost (metric). This enables load balancing and redundancy across network paths. ECMP operates on Layer-3 (L3) of the Open Systems Intercommunication (OSI) model. The path can be selected by different methods, with the most common one using a hash, which is typically based on source IP address/destination IP addresses, IP protocol, and Layer-4 (L4) source/destination ports. ECMP is widely used in Leaf-Spine architectures to distribute traffic evenly across spine switches. It ensures high bandwidth and fault tolerance in large-scale data centers. Additional details of the ECMP logic in the NPAL is illustrated and described below with respect to FIG. 3. ECMP deletion and creation can be done in a synchronous way. In a synchronous mode, every ECMP group creation/deletion is getting acknowledgement from lower layer software, i.e., virtual bridge and driver. Since each group is waiting for acknowledgement, using synchronous mode will be slower. Aspects and embodiments of the present disclosure can perform ECMP deletion and creation in an asynchronous way. In an asynchronous mode, ECMP groups creation/deletion is done in a batch, and an acknowledgement is not sent per group, but per batch of groups. Also, in the asynchronous mode, two threads are used in parallel to perform the operation. In the asynchronous mode, the creation/deletion time is much lower (e.g., up to 94% improvement in speed) as compared to the synchronous mode. Additional details of the synchronous and asynchronous modes are illustrated and described below with respect to FIG. 4 and FIG. 5. A DPU can be an integrated circuit or a System on a Chip (SoC) that is considered a data center infrastructure on a chip. The CPU can include DPU hardware and DPU software (e.g., software framework with acceleration libraries). The DPU hardware can include a CPU (e.g., a single-core or multi-core CPU), one or more hardware accelerators, memory, one or more physical host interfaces that operatively couple to one or more host devices (e.g., a CPU of a host device), and one or more physical network interfaces that operatively couple to a network (e.g., a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, network adapters, NVLink switches, and/or a combination thereof). The DPU can handle network data path processing of network traffic data, whereas a host device can control path initialization and exception processing. The acceleration hardware engine (e.g., DPU hardware) can be used to offload and filter network traffic based on predefined filters using the hardware capabilities of the acceleration hardware engine. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services. A DPU can provide accelerated networking services (also referred to as Host Based Network service (HBN) service to one or more host devices. The DPU network services can be used for accelerating L2 protocols, L3 protocols, tunneling protocols, or the like, on the DPU hardware. The HBN infrastructure is based on SFC topology, where a single virtual bridge (e.g., Open vSwitch (OVS) bridge) is controlled by the HBN service, providing all accelerated networking capabilities. The HBN service can support different protocols and different network capabilities, such as Access Control Lists (ACLs), an Equal-Cost Multi-Path (ECMP), tunneling, Connection Tracking (CT), Quality of Service (QoS) rule, Spanning Tree Protocol (STP), virtual local area network (VLAN) mapping, network address translations (NATs), software-defined networking (SDN), multi-protocol label switching (MPLS), etc. From SW perspective, the NIC/DPU needs to support ECMP in all software stacks, including the NIC/DPU firmware (FW), drivers, a virtual bridge (or virtual switch), and the NPAL on top of the virtual bridge (or virtual switch). As described herein, the NPAL includes a set of tables in specific order and logic which is optimized to be accelerated by NIC/DPU HW, providing customers and users rich set of capabilities and high performance. Network Pipeline Abstraction Layer (NPAL) with ECMP Optimizations for Creating and Deleting ECMP Groups. ECMP is widely used in Leaf-Spine architectures to distribute traffic evenly across spine switches. It ensures high bandwidth and fault tolerance in large-scale data centers. Additional details of the ECMP logic in the NPAL is illustrated and described below with respect to FIG. 3.

ECMP deletion and creation can be done in a synchronous way. In a synchronous mode, every ECMP group creation/deletion is getting acknowledgement from lower layer software, i.e., virtual bridge and driver. Since each group is waiting for acknowledgement, using synchronous mode will be slower.

Aspects and embodiments of the present disclosure can perform ECMP deletion and creation in an asynchronous way. In an asynchronous mode, ECMP groups creation/deletion is done in a batch, and an acknowledgement is not sent per group, but per batch of groups. Also, in the asynchronous mode, two threads are used in parallel to perform the operation. In the asynchronous mode, the creation/deletion time is much lower (e.g., up to 94% improvement in speed) as compared to the synchronous mode. Additional details of the synchronous and asynchronous modes are illustrated and described below with respect to FIG. 4 and FIG. 5.

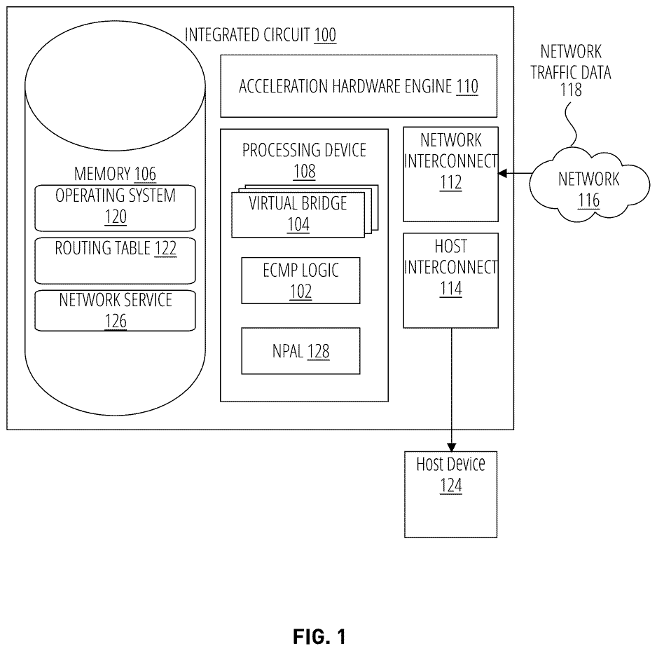

FIG. 1 is a block diagram of an integrated circuit 100 with ECMP logic for ECMP optimization according to at least one embodiment. The integrated circuit 100 can be a DPU, a NIC, a Smart NIC, a network interface device, or a network switch. The integrated circuit 100 includes a memory 106, a processing device 108, acceleration hardware engine 110, a network interconnect 112, and a host interconnect 114. The processing device 108 is coupled to the memory 106, the acceleration hardware engine 110, the network interconnect 112, and the host interconnect 114. The processing device 108 can host one or more the virtual bridges 104 and an NPAL 128 that supports multiple network protocols and network functions in a network pipeline. The network pipeline includes a set of tables and logic organized in a specific order to be accelerated by the acceleration hardware engine 110. The NPAL 128 can support ECMP operations, including optimizations of ECMP group creations and deletions, as described herein.

A virtual bridge 104 (also referred to as a virtual switch) is software that operates within a computer network to connect different segments or devices, much like a physical network bridge, but in a virtualized environment. It is a core component in network virtualization, enabling the connection of virtual machines (VMs), containers, and other virtual network interfaces to each other and to the physical network, simulating traditional Ethernet network functions purely in software. Virtual bridges 104 allow for the creation and management of isolated network segments within a single physical infrastructure, facilitating communication, enforcing security policies, and providing bandwidth management, all while offering the flexibility and scalability needed in dynamic virtualized and cloud environments. The virtual bridges 104 can be Open vSwitch (OVS) bridges. An OVS bridge functions as a virtual switch at the heart of the Open vSwitch architecture, enabling advanced network management and connectivity in virtualized environments. It operates by aggregating multiple network interfaces into a single logical interface, managing the traffic flow between VMs on the same physical host, as well as the external network. Unlike traditional virtual bridges, the OVS bridge supports a wide array of networking features, such as VLAN tagging, traffic monitoring with sFlow and NetFlow, Quality of Service (QoS), and Access Control Lists (ACLs), offering enhanced flexibility and control for network administrators. The OVS bridge efficiently directs network traffic, based on pre-defined policies and rules, providing an essential tool for building complex, multi-tenant cloud and data center networks.

In particular with respect to FIG. 1, the virtual bridges 104 can provide network connectivity between VMs executed on the same integrated circuit 100 or a separate host device, containers, and/or physical devices. In short, the virtual bridges 104 allows VMs on a single physical host to communicate with each other and with the external network 116. The virtual bridges 104 can emulate the functionality of a physical network switch but operates at a software level within the integrated circuit 100. The virtual bridges 104 can manage network traffic data 118, directing data packets between VMs on the same host or between VMs and the physical network using ports. These ports can be configured for various policies like security settings, QoS rules, etc. The virtual bridges 104 can segment network traffic to provide isolation between different virtual networks. The virtual bridges 104 can provide an interface between the virtualized environment and the physical network, allowing VMs to communicate outside their host. The virtual bridges 104 can support standard networking protocols and features, such as VLAN tagging, Layer-2 (L2) forwarding, Layer-3 (L3) capabilities, tunneling protocols (e.g., Virtual Extensive LAN (VXLAN), Generic Routing Encapsulation (GRE), and the Geneve protocol), flow-based forwarding, OpenFlow Support, integration with virtualization platforms (e.g., VMware, KVM, Xen, and others, enabling network connectivity for virtual machines and containers), extensibility, traffic monitoring and mirroring, security, multi-platform support (e.g., Linux, FreeBSD, Windows, etc.), and the like. For Layer-2 Switching, one or more of the virtual bridges 104 acts as a Layer-2 Ethernet switch, enabling the forwarding of Ethernet frames between different network interfaces, including virtual and physical ports. For Layer-3 Routing, one or more of the virtual bridges 104 supports Layer-3 IP routing, allowing it to route traffic between different IP subnets and perform IP-based forwarding. The virtual bridges 104 can support VLAN tagging and allow for the segmentation of network traffic into different VLANs using VLAN tagging. The virtual bridges 104 can use flow-based forwarding where network flows are classified based on their characteristics, and packet forwarding decisions are made based on flow rules, as well as enforce security policies and access control. OVS is commonly used in data center and cloud environments to provide network agility, flexibility, and automation. It plays a vital role in creating and managing virtual networks, enabling network administrators to adapt to the changing demands of modern, dynamic data centers.

In at least one embodiment, the virtual bridges 104 can use the OVS and OF technologies. The virtual bridges 104 can be controlled by a network controller (also referred to as a network service 126) to make decisions about how traffic should be routed through the network. As described herein, a network controller (e.g., SDN controller) is a centralized entity that manages flow control to the networking devices. The OF protocol can be used to interact directly with the forwarding plane of network devices, such as virtual or physical switches and routers. In at least one embodiment, the virtual bridges 104 can use flow tables that contain rules for how packets should be handled. Each flow table contains a set of flow entries. The flow entry defines what to do with packets that match certain criteria. An entry can have three parts: match fields, actions, and counters. The match fields define packet attributes to match, such as source/destination Internet Protocol (IP) addresses, Media Access control (MAC) addresses, port numbers, VLAN tags, etc. The actions can define what to do with a matching packet, such as forwarding it to a specific port, modifying fields in the packet, or dropping it. The counters can be used to keep track of the number of packets and bytes for each flow. Since the virtual bridges 104 is virtualized, the virtual bridges 104 can create rules at a software level, a data path (DP) level, and at a hardware level. A rule created at the software level is referred to as a software (SW) rule or an OF rule. A rule created at the DP level is referred to as a DP rule. A rule created at the hardware level is referred to as a hardware (HW) rule. When a SW rule is created, corresponding DP and HW rules are created. A network controller can add, update, or delete flow entries, changing the configuration settings.

In another embodiment, the virtual bridges 104 is a Standard Virtual Switch or a Distributed Virtual Switch. In another embodiment, the virtual bridges 104 is an SDN-based switch that is integrated with an SDN controller. The integrated circuit 100 can be used in data centers, cloud computing environments, development and testing environments, network function virtualization (NFV) environments, or the like. The virtual bridges 104 can be used in a data center where server virtualization is common to facilitate communication within and between servers efficiently. The virtual bridges 104 in the cloud computing environment can enable multi-tenant networking, allowing different clients to have isolated network segments. The virtual bridges 104 can allow network function virtualizations (e.g., NFVs) to be connected and managed within virtual infrastructures. Some advantages of the virtual bridges 104 is that the virtual bridges 104 can be easily configured or reconfigured without physical intervention, can reduce the need for physical network hardware and associated maintenance, offers the ability to create isolated networks for different applications or tenants. In summary, the virtual bridges 104 is a software-based device that performs the networking functionalities of a physical switch in a virtualized environment (e.g., data centers and cloud computing environments) and provides flexibility, isolation, and efficient network management in the virtualized environment.

In at least one embodiment, the integrated circuit 100 can also host one or more hypervisors and one or more virtual machines (VMs). The network traffic data 118 can be directed to the respective VM by the virtual bridges 104.

In at least one embodiment, the integrated circuit 100 stores an operating system 120 (OS 120) in memory 106. The integrated circuit 100 can execute the operating system 120 using the processing device 108. In at least one embodiment, the integrated circuit 100 stores routing table 122 in memory 106. In at least one embodiment, the integrated circuit 100 stores a network service 126 in memory 106.

In at least one embodiment, a computing system includes the host device 124 and the integrated circuit 100. The integrated circuit 100 is coupled to the host device and the network 116. The integrated circuit 100 include the network interconnect 112 coupled to the network 116, and the host interconnect 114 coupled to the host device 124. The integrated circuit 100 include the acceleration hardware engine 110, and memory 106. The processing device 108 can store instructions that, when executed by the integrated circuit 100, are to provide a virtual bridge (104) and the NPAL 128. The NPAL 128 supports multiple network protocols and network functions in a network pipeline, including a set of tables and logic organized in a specific order to be accelerated by the acceleration hardware engine 110. In at least one embodiment, the virtual bridge 104 can asynchronously receive, from a first thread of the NPAL 128, one or more create requests (also referred to as creation requests or add requests) to create an ECMP group. The virtual bridge 104 can asynchronously create the respective ECMP group in response to each of the one or more create requests. The virtual bridge 104 can receive, from a second thread of the NPAL, a first request for acknowledgement for the one or more create requests. The virtual bridge 104 can determine that each of the one or more ECMP groups has been successfully created. The virtual bridge 104 can send, to the second thread, a first acknowledgement in response to the first request for acknowledgement, the first acknowledgement indicating the one or more ECMP groups have been successfully created in the virtual bridge. The virtual bridge 104 can perform an ECMP operation using at least one ECMP group.

In a further embodiment, the virtual bridge 104 can asynchronously receive, from the first thread, one or more delete requests (also referred to as deletion requests or remove requests) to delete an ECMP group. The virtual bridge 104 can asynchronously delete the respective ECMP group in response to each of the one or more delete requests. The virtual bridge 104 can receive, from the second thread, a second request for acknowledgement for the one or more delete requests. The virtual bridge 104 can determine that each of the one or more ECMP groups has been successfully deleted. The virtual bridge 104 can send, to the second thread, a second acknowledgement in response to the second request for acknowledgement, the second acknowledgement indicating the one or more ECMP groups have been successfully deleted. The virtual bridge 104 can perform an ECMP operation using at least one ECMP group.

In a further embodiment, the virtual bridge 104 can asynchronously receive, from the first thread, one or more additional create requests to create an additional ECMP group. The virtual bridge 104 can receive, from the second thread, a second request for acknowledgement for the one or more additional create requests. The virtual bridge 104 can determine that a group creation of at least one of the additional ECMP groups has failed. The virtual bridge 104 can send, to the first thread, a notification indicating the group creation has failed.

In addition to support ECMP optimizations for creating and deleting ECMP groups, the NPAL 128 can support fast link recovery when there is a link failure and an ECMP group needs to be updated to reflect a new network topology.

Link failure in network topologies refers to a situation where a communication link between two network devices, such as routers, NICs, switches, or hosts, becomes unavailable due to various reasons such as hardware failure, cable disconnection, or network congestion. Link failures can significantly impact the performance, availability, and reliability of network services, especially in large-scale or critical environments like data centers or enterprise networks. The are several reasons which might cause link failure, such as physical link failures (e.g., damage or disconnection of cables due to fiber cuts, broken Ethernet cables, etc.), device failures (e.g., hardware failures causing interfaces to go down), congestion or overload (i.e., network links overloaded with too much traffic causing timeouts or packet drops), software bugs or misconfigurations that cause a network device to drop connections, power failures, maintenance activities (e.g., planned outages for maintenance or upgrades might also cause temporary link failures), or the like. There can be different implications for link failures as described above. Due to the implications for link failures, it is important to have fast recovery when link goes down. In particular, when link goes down, an ECMP group must be updated immediately to reflect that a specific link is no longer available. Also, when the link goes up, the ECMP group must be updated immediately with the recovered link to allow better network utilization.

As described below in more detail, the NPAL can operate as an accelerated network pipeline and virtual switching hardware offload mechanism that periodically monitors links. In at least one embodiment, a user can configure the NPAL to support fast link recovery, enabling link monitoring by the virtual switch. For example, all ports in a specific ECMP group can be monitored using inter-process communication (IPC) messages, such as Linux Netlink messages from a Linux kernel. If a link goes down (i.e., experiences a link failure), the virtual switch identifies the link as being down and updates the ECMP group immediately by removing the link from the ECMP group. That is, the virtual switch updates the ECMP group in the tables in a bridge and/or a router of the network pipeline to remove the failed link. Once the ECMP group is updated, the traffic can be distributed to other links in the ECMP group. If a link goes up (i.e., it no longer experiences a link failure), the virtual switch identifies the link as being up and updates the ECMP group immediately by adding the link from the ECMP group. That is, the virtual switch updates the ECMP group in the tables in the bridge and/or the router of the network pipeline to add the recovered link (also referred to as a new link). Once the ECMP group is updated, the traffic can be distributed to the new link along with the other links in the ECMP group.

In a further embodiment, the virtual bridge 104 can monitor a link availability of each of a plurality of links to a destination, the plurality of links being specified in an initial group of identifiers of an ECMP group. The virtual bridge 104 can detect a link failure of a first link of the plurality of links. The NPAL 128 can remove a first link identifier, associated with the first link, from the initial group of link identifiers to obtain a modified group of link identifiers. The NPAL 128 can cause a routing table in the NPAL to be updated to remove the first link identifier. The acceleration hardware engine 110 can process network traffic data using the network pipeline and distribute the network traffic data to only the remaining links of the plurality of links corresponding to the modified group of identifiers. In at least one embodiment, the NPAL 128 include the ECMP logic 102 and the ECMP logic 102 can receive a first packet prior to the link failure of the first link, and perform an Internet Protocol (IP) address lookup for the first packet to identify an ECMP group identifier associated with the plurality of links. The ECMP logic 102 can hash the ECMP group identifier to identify any one of the plurality of links. The ECMP logic 102 can receive a second packet after the link failure of the first link. The ECMP logic 102 can perform an IP address lookup for the second packet to identify the ECMP group identifier. The ECMP logic 102 can hash the ECMP group identifier to identify any one of the remaining links.

In a further embodiment, the virtual bridge 104 can monitor the link availability of each of the plurality of links to the destination. The virtual bridge 104 can detect a link recovery of the first link. The virtual bridge 104 can add the first link identifier to the modified group of link identifiers to obtain the initial group of link identifiers. The virtual bridge 104 can cause the routing table in the NPAL 128 to be updated to add the first link identifier. The acceleration hardware engine 110 can process subsequent network traffic data using the network pipeline and distribute the subsequent network traffic data to the plurality of links corresponding to the initial group of identifiers. In at least one embodiment, the NPAL 128 include the ECMP logic 102 and the ECMP logic 102 can receive a first packet prior to the link recovery of the first link. The ECMP logic 102 can perform an Internet Protocol (IP) address lookup for the first packet to identify an ECMP group identifier associated with the plurality of links. The ECMP logic 102 can hash the ECMP group identifier to identify any one of the remaining links. The ECMP logic 102 can receive a second packet after the link recovery of the first link. The ECMP logic 102 can perform an IP address lookup for the second packet to identify the ECMP group identifier. The ECMP logic 102 can hash the ECMP group identifier to identify any one of the plurality of links.

In at least one embodiment, the virtual bridge 104 is controlled by the NPAL 128, and the virtual bridge 104 can send a first notification to the NPAL 128 of the link failure of the first link. The NPAL 128 can update the routing table 122 in response to the first notification. The routing table 122 can store configuration information associated with the initial group of identifiers. The virtual bridge 104 can send a second notification to the NPAL 128 of the link recovery of the first link, and the NPAL 128 can update the routing table 122 in response to the second notification.

In at least one embodiment, the integrated circuit 100 is a DPU, a NIC, a network adapter, a network interface device, a switch, or the like. In at least one embodiment, the ECMP logic 102 and routing table 122 can be implemented in an NPAL, including a set of applications programming interfaces (APIs) or classes that provide a unified interface to one or more applications executed by the integrated circuit 100 or the host device 124 coupled to the integrated circuit 100.

As illustrated in FIG. 1, the integrated circuit 100 can include ECMP logic 102. The ECMP logic 102 can be part of the virtual bridge 104, the NPAL 128, or can be separate from the virtual bridge 104 and the NPAL 128. In other embodiments, the ECMP logic 102 can be implemented in processors, computing systems, CPUs, DPUs, smart NICs, IPUs, or the like. In at least one embodiment, the DPU includes DPU hardware, including a processing device and an acceleration hardware engine. The DPU includes memory operatively coupled to the DPU hardware. The memory can store DPU software including a virtual bridge and an NPAL that supports multiple network protocols and network functions in a network pipeline. The network pipeline includes a set of tables and logic organized in a specific order to be accelerated by the acceleration hardware engine. The acceleration hardware engine can process network traffic data using the network pipeline. The network pipeline can be optimized for network services running on the DPU.

In at least one embodiment, the integrated circuit 100 can be deployed in a Data Center (DC) network or a Service Provider (SP) network. A data center (DC) network is the foundational infrastructure that facilitates communication, data exchange, and connectivity between different computational resources, storage systems, and networking devices within a data center. It is designed to support high-speed data transmission, reliable access to distributed resources, and efficient management of data flows across various physical and virtual platforms. At its core, a DC network integrates a multitude of switches, routers, firewalls, and load balancers, orchestrated by advanced networking protocols and software-defined networking (SDN) technologies to ensure optimal performance, scalability, and security. The architecture of a DC network typically includes both the physical backbone, with high-capacity cables and switches ensuring bandwidth and redundancy, and the virtual overlay, which enables flexibility, quick provisioning, and resource optimization through virtual networks. A well-designed DC network supports a range of applications, from enterprise services to cloud computing and big data analytics, by providing the infrastructure to handle the massive amounts of data, complex computations, and application workloads typical of modern data centers. It plays a crucial role in disaster recovery, data replication, and high availability strategies, ensuring that data center services remain resilient against failures and efficient under varying loads. A Service Provider (SP) network refers to the expansive, high-capacity communication infrastructure operated by organizations that offer various telecommunications, internet, cloud computing, and digital services to businesses, residential customers, and other entities. These networks are engineered to provide wide-ranging coverage, connecting numerous geographical locations, including urban centers, remote areas, and international destinations, to facilitate global communication and data exchange. The architecture of an SP network is multi-layered, incorporating a mix of technologies such as fiber optics, wireless transmission, satellite links, and broadband access to achieve widespread connectivity. Central to these networks are high-performance backbone networks, which are responsible for the high-speed transmission of massive volumes of data across long distances. On top of the physical infrastructure, SP networks deploy advanced networking technologies, including MPLS, software-defined networking (SDN), and network function virtualization (NFV), to enhance the efficiency, flexibility, and scalability of service delivery. Service Provider networks are designed to support a vast array of services, from conventional voice and data services to modern cloud-based applications and streaming services, addressing the evolving demands of consumers and businesses alike. They are crucial for the implementation of the internet, mobile communications, enterprise networking solutions, and the emerging Internet of Things (IoT) ecosystem, ensuring connectivity and accessibility to digital resources and services on a global scale.

### Data Processing Units (DPUS)

In modern network architectures, a DPU can be used to provide a set of software-defined networking, storage, security, and management services at a data-center scale with the ability to offload, accelerate, and isolate data center infrastructure. The DPU can offload processing tasks that a server's central processing unit (CPU) normally handles, such as any combination of encryption/decryption, firewall, transport control protocol/Internet Protocol (TCP/IP), and HyperText Transport Protocol (HTTP) processing, networking operations. A DPU can be an integrated circuit or a System on a Chip (SoC) that is considered a data center infrastructure on a chip. The CPU can include DPU hardware and DPU software (e.g., software framework with acceleration libraries). The DPU hardware can include a CPU (e.g., a single-core or multi-core CPU), one or more hardware accelerators, memory, one or more physical host interfaces that operatively couple to one or more host devices (e.g., a CPU of a host device), and one or more physical network interfaces that operatively couple to a network (e.g., a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, network adapters, NVLink switches, and/or a combination thereof). The DPU can handle network data path processing of network traffic data, whereas a host device can control path initialization and exception processing. The acceleration hardware engine (e.g., DPU hardware) can be used to offload and filter network traffic based on predefined filters using the hardware capabilities of the acceleration hardware engine. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services.

A DPU can provide accelerated networking services (also referred to as Host Based Network service (HBN) service to one or more host devices. The DPU network services can be used for accelerating L2 protocols, L3 protocols, tunneling protocols, or the like, on the DPU hardware. The HBN infrastructure is based on SFC topology, where a single virtual bridge (e.g., Open vSwitch (OVS) bridge) is controlled by the HBN service, providing all accelerated networking capabilities. The HBN service can support different protocols and different network capabilities, such as Access Control Lists (ACLs), an Equal-Cost Multi-Path (ECMP), tunneling, Connection Tracking (CT), Quality of Service (QoS) rule, Spanning Tree Protocol (STP), virtual local area network (VLAN) mapping, network address translations (NATs), software-defined networking (SDN), multi-protocol label switching (MPLS), etc.

From SW perspective, the NIC/DPU needs to support ECMP in all software stacks, including the NIC/DPU firmware (FW), drivers, a virtual bridge (or virtual switch), and the NPAL on top of the virtual bridge (or virtual switch). As described herein, the NPAL includes a set of tables in specific order and logic which is optimized to be accelerated by NIC/DPU HW, providing customers and users rich set of capabilities and high performance.

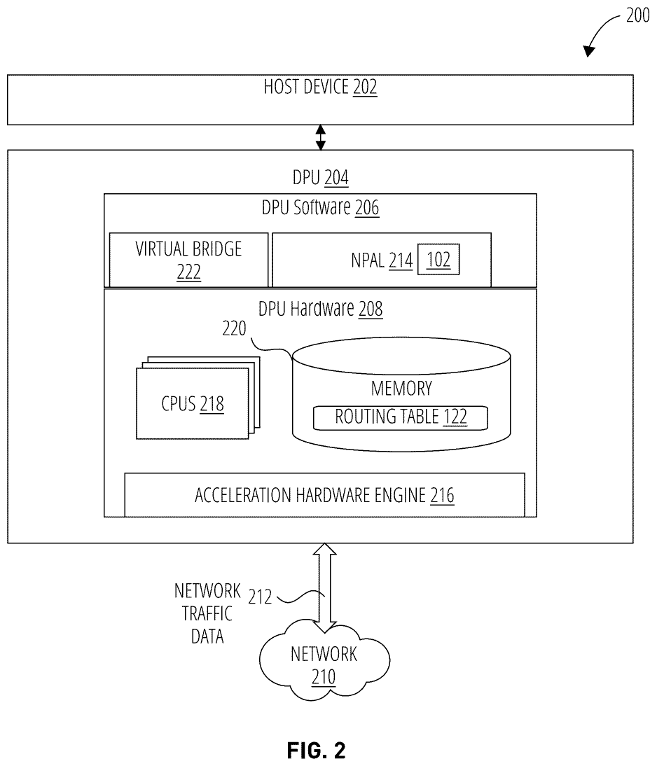

In at least one embodiment, the ECMP logic 102 can be implemented as part of a hardware-accelerated service on an agentless hardware product, such as a DPU. The hardware-accelerated service can be part of the NVIDIA OVS-DOCA, developed by Nvidia Corporation of Santa Clara, California. OVS-DOCA, which is the new OVS infrastructure for DPU, is based on the open-source OVS with additional features, new acceleration capabilities, and the OVS backend is purely DOCA based. In at least one embodiment, a DPU includes DPU hardware, including a processing device and an acceleration hardware engine, and a memory operatively coupled to the DPU hardware. The memory can store instructions that, when executed by the DPU hardware, provide a virtual bridge and a NPAL with ECMP optimizations for creating and deleting ECMP groups. An example DPU is illustrated and described below with respect to FIG. 2.

FIG. 2 is a block diagram of an example computing system 200 with a DPU 204 having an NPAL 214 with ECMP optimizations in an optimized and accelerated network pipeline to be accelerated by an acceleration hardware engine 216 according to at least one embodiment. The computing system 200 includes the DPU 204 coupled between a host device 202 and a network 210. In at least one embodiment, the DPU 204 is a System on a Chip (SoC) that is considered a data center infrastructure on a chip. The DPU 204 is a specialized processor designed to offload and accelerate networking, storage, and security tasks from the central processing unit (CPU) of the host device 202, thus enhancing overall system efficiency and performance. The DPU 204 can be used in data centers and cloud computing environments to manage data traffic more efficiently and securely.

The DPU 204 can include a network interconnect (e.g., one or more Ethernet ports) operatively coupled to the network 210. The network interconnect can be high-speed network interfaces that enable them to connect directly to the data center network infrastructure. These interfaces can support various speeds (e.g., 10 Gbps, 25 Gbps, 40 Gbps, or higher), depending on the model and deployment requirements. The network 116 may include a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, and/or a combination thereof.

The DPU 204 can be coupled to a CPU of the host device 202 (or multiple host devices or servers) via one or more host interconnects (e.g., Peripheral Component Interconnect Express (PCIe)). PCIe provides a high-speed connection between the DPU 204 and the host device's CPU, allowing for the fast transfer of data and instructions. This connection is used for offloading tasks from the CPU and for ensuring that the DPU 204 can access system memory and storage resources efficiently. To enable communication between the host device 202 and the DPU 204, specialized software drivers and firmware are installed on the host device 202. These software components allow the host's operating system and applications to interact with the DPU 204, offloading specific tasks to it and retrieving processed data. In virtualized environments, the DPU 204 can also interface with hypervisors or container management systems. This allows the DPU to support multiple virtual machines (VMs) or containers by providing them with virtualized network functions, network isolation, and security features without burdening the host device's CPU. The DPU 204 can utilize Direct Memory Access (DMA) to read from and write to the host device's memory directly, bypassing the CPU to reduce latency and free up CPU resources for other tasks. This enables efficient data movement between the host memory, the DPU 204, and the network 210. In at least one embodiment, the DPU 204 includes a direct memory access (DMA) controller (not illustrated in FIG. 2) coupled to a host interface. The DMA controller can read the data from the host's physical memory via a host interface. In at least one embodiment, the DMA controller reads data from the host's physical memory using the PCIe technology. Alternatively, other technologies can be used to read data from the host's physical memory. In other embodiments, the DPU 204 may be any computing system or computing device capable of performing the techniques described herein.

Once physically connected, the DPU 204 is configured to communicate with the network 210. This involves setting up IP addresses, VLAN tags (if using virtual networks), and routing information to ensure the DPU 204 can send and receive data packets to and from other devices on the network 210. As described herein, the DPU 204 executes network-related tasks, such as packet forwarding, encryption/decryption, load balancing, and Quality of Service (QoS) enforcement. By doing so, it effectively becomes an intelligent network interface controller with enhanced capabilities, capable of sophisticated data processing and traffic management.

In at least one embodiment, the DPU 204 includes DPU hardware 208 and DPU software 206 (e.g., software framework with acceleration libraries). The DPU hardware 208 can include one or more CPUs 218 (e.g., a single-core or multi-core CPU), an acceleration hardware engine 216 (or multiple hardware accelerators), memory 220, and the network and host interconnects. In at least one embodiment, the DPU 204 includes DPU software 206, including software framework and acceleration libraries. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services.

The DPU software 206 also includes a virtual bridge 222 and a NPAL 214. The routing table 122 is similar to the virtual bridge 104 of FIG. 1. The NPAL 214 is similar to the NPAL 128 of FIG. 1. The NPAL 214 can include a set of APIs or classes that provide a unified interface for performing common networking operations in a network pipeline that is optimized for hardware acceleration on an acceleration hardware engine 216. The set of APIs or class can provide a unified interface to one or more applications, network services, or other logic executed by the DPU 204 or host device 202, or both. The network pipeline can include a set of tables and logic in a specific order, the network pipeline being optimized to be accelerated by an acceleration hardware engine 216 of the DPU hardware 208.

Using an NPAL 214 in the DPU 204 can provide various benefits, including operational independence, encapsulation of logic, performance, code reusability, platform independence, or the like. For example, developers can write agnostic code, allowing applications (e.g., network services) to work with different underlying access logic and network functionality. The NPAL 214 can encapsulate the access or network function-related logic, making it easier to manage and maintain the codebase. systems. Changes to the schema or underlying technology can be isolated within the NPAL implementation. The NPAL 214 can provide an optimized and high-performance pipeline to address different networking requirements and functionality. By separating access logic from application logic, developers can reuse the NPAL components across multiple parts of the application (network service), promoting code reuse and maintainability. The NPAL 214 can abstract away platform-specific differences, data types, and other access or network function-related features, enabling the application (network service) to run on different platforms and environments seamlessly. Overall, the NPAL 214 can be a powerful tool for building flexible, scalable, and maintainable network function-driven applications, offering a level of abstraction that simplifies interactions between network functions and promotes code efficiency and portability.

In at least one embodiment, the DPU includes DPU hardware, including a processing device and an acceleration hardware engine. The DPU includes memory operatively coupled to the DPU hardware. The memory can store DPU software including an NPAL 214 that supports multiple network protocols and network functions in a network pipeline. The network pipeline includes a set of tables and logic organized in a specific order to be accelerated by the acceleration hardware engine. The acceleration hardware engine can process network traffic data using the network pipeline. The network pipeline can be optimized for network services running on the DPU. During operation, the DPU hardware 208 can receive the network traffic data 212 from the network 210 and process the network traffic data 212 using the optimized and accelerated network pipeline programmed by the NPAL 214.

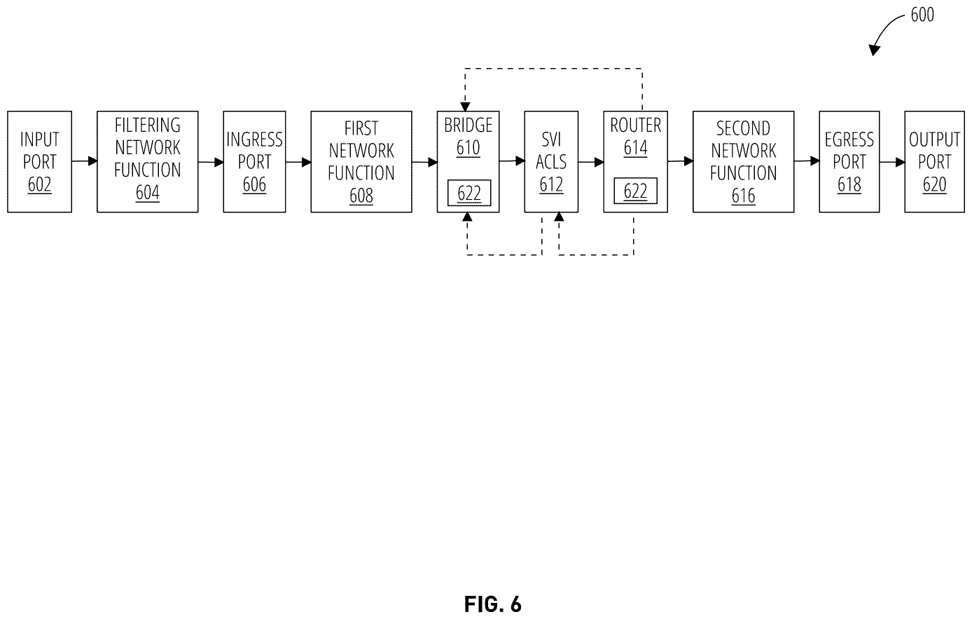

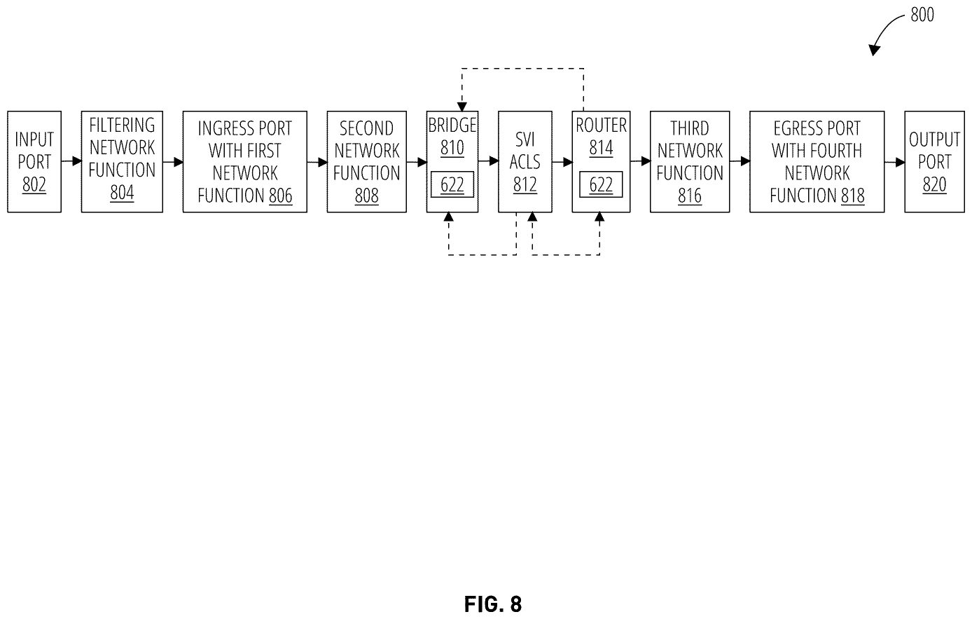

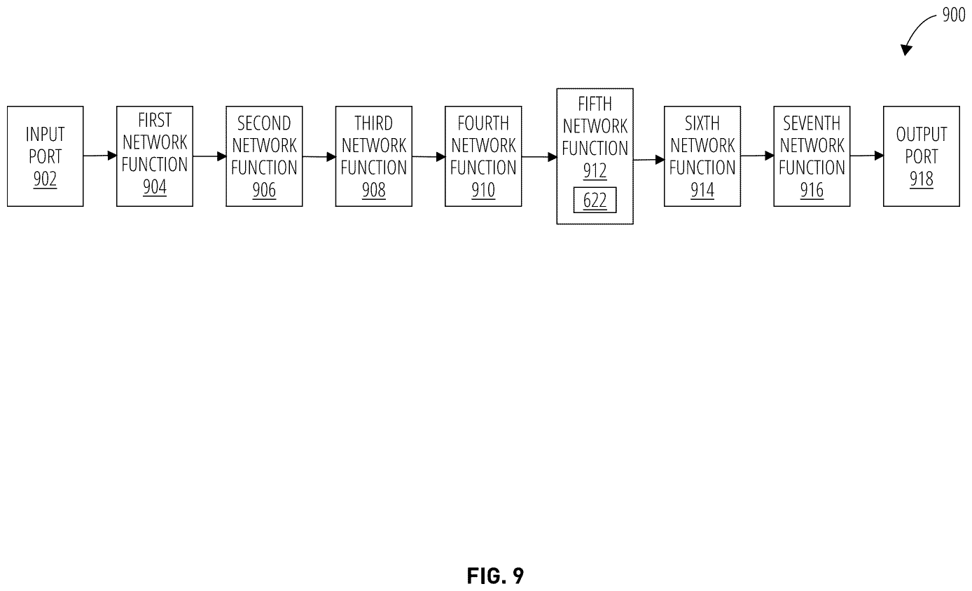

As described herein the NPAL 214 supports multiple network protocols and network functions in a network pipeline. The network pipeline includes a set of tables and logic organized in a specific order to be accelerated by the acceleration hardware engine 216. The acceleration hardware engine 216 can process network traffic data 212 using the network pipeline. In at least one embodiment, the network pipeline includes an input port, an ingress dynamic or static Access Control List (ACL), a bridge, a router, an egress dynamic or static ACL, and an output port. Examples of the optimized and accelerated network pipelines are illustrated and described below with respect to FIG. 6, FIG. 8, and FIG. 9.

In at least one embodiment, the memory 220 stores the routing table 122 used for ECMP routing. The ECMP logic 102, as described above with respect to FIG. 1, can be implemented in the DPU software 206 to perform ECMP operations as described herein. As illustrated in FIG. 2, the ECMP logic 102 is implemented in the NPAL 214. The ECMP logic 102 can leverage the acceleration hardware engine 216 (e.g., DPU hardware 208) to offload and filter network traffic data 212 based on predefined filters using the hardware capabilities of the acceleration hardware engine 216. The DPU hardware 208 can receive network traffic data 212 over the network ports from a second device (or multiple devices) on the network 210.

In at least one embodiment, the DPU software 206 can perform several actions when creating the virtual bridges 104 and the corresponding interface mappings to ensure proper configuration and integration within the virtualized environment. The DPU software 206 can initialize the creation of a virtual bridge by allocating the resources and setting up the initial configuration parameters. These configurations can be stored in configuration files. Also, the routing table 122 can be defined for different control protocol types. The configuration parameters can define the bridge name, network protocols to be supported, and any specific settings related to performance or security. A virtual network interface is created to act as the virtual bridge. This interface serves as the anchor point for all the virtual and physical interfaces that will be connected to the virtual bridge. The DPU software 206 can identify and link the designated physical (e.g., Ethernet ports) and virtual interfaces (e.g., virtual machine network adapters) to the newly created virtual bridge. This action involves configuring each interface's settings to ensure compatibility and optimal communication within the virtual bridge. The DPU software 206 can configure the networking protocols. Networking protocols and services, such as Spanning Tree Protocol (STP) for loop prevention, are configured on the virtual bridge. The DPU software 206 may also set up VLAN tagging for traffic segmentation, QoS policies for traffic prioritization, and security features like Access Control Lists (ACLs). The DPU software 206 can assign IP addresses to the bridge interfaces. If the virtual bridge acts as a Layer-3 (L3) switch, the DPU software 206 assigns IP addresses to the bridge interface, enabling it to participate in IP routing between the different connected networks or devices. The DPU software 206 can provide a unified interface to allow for centralized control and monitoring of the network. Network administrators can manage the virtual bridge alongside other virtual network components through the unified interface. The DPU software 206 can enable monitoring and management features for the virtual bridge, allowing network administrators to observe traffic flow, identify potential issues, and make adjustments, as needed, to optimize network performance and security. Throughout these steps, the software ensures that the virtual bridge is seamlessly integrated into the existing network architecture, providing a flexible and efficient way to connect various network segments within virtualized environments.

As described herein, the NPAL 214 can provide support for different network protocols and capabilities in network functions. Different network protocols and capabilities serve as the backbone of modern networking, enabling a wide array of functionalities from basic connectivity to advanced security and traffic optimization. The network functions can include network functions, including a set of tables and logic to perform the corresponding network function, such as ACL, ECMP routing, tunneling, Connection Tracking (CT), NAT, QoS, or the like. ACLs are a fundamental network security feature that allows or denies traffic based on a set of rules. These lists are applied to network interfaces, controlling the flow of packets either at the ingress or egress point. The rules can specify various parameters such as source and destination IP addresses, port numbers, and the protocol type to finely tune the traffic filtering process, enhancing security and compliance. ECMP is a routing strategy used to distribute outgoing network traffic across multiple paths that have the same cost. By balancing the load evenly across these paths, ECMP can significantly increase the bandwidth and reliability of the network. This protocol is particularly useful in data center and cloud environments, where high availability and scalability are important. Tunneling encapsulates one protocol or session inside another protocol, allowing data to traverse networks with incompatible address spaces or architectures. It is widely used in implementing Virtual Private Networks (VPNs), where secure tunnels over the internet enable private communications. Protocols like IPsec and GRE are common examples that facilitate tunneling for security and protocol encapsulation purposes. CT refers to the ability of a network device (such as a firewall or a router) to maintain the state information of network connections passing through it. This capability enables the device to make more informed decisions about which packets to allow or block, based on the context of the session to which they belong. CT is crucial for implementing stateful firewalls and NAT (Network Address Translation) functionalities. QoS capabilities refers to mechanisms that prioritize certain types of traffic to ensure the performance of applications, especially in congested network scenarios. The network functions can include other types of network functions, such as Segment Routing (SR), Multiprotocol Label Switching (MPLS), Network Virtualization, Software-Defined Networking (SDN), or the like. SR enables the source of a packet to define the path that the packet takes through the network using a list of segments, improving the efficiency and flexibility of routing. MPLS is a method for speeding up and shaping network traffic flows, where data packets are labeled and quickly routed through pre-determined paths in the network. Network Virtualization involves abstracting physical network equipment and resources into a virtual network, allowing for more flexible and efficient resource management. Software-Defined Networking (SDN) decouples the network control and forwarding functions, enabling programmable network management and the efficient orchestration of network services. These protocols and capabilities represent just a fraction of the vast array of technologies that underlie modern networking, each playing a specific role in ensuring that data is transported efficiently, securely, and reliably across the digital infrastructure.

In at least one embodiment, the DPU 204 includes a set of applications programming interfaces (APIs) or classes that provide a unified interface to one or more applications executed by the DPU 204 or the host device 202 coupled to the DPU 204.

In at least one embodiment, the DPU 204 includes the DPU hardware 208, including a processing device and an acceleration hardware engine, and memory operatively coupled to the DPU hardware. The memory can store instructions that, when executed by the DPU hardware, are to provide the virtual bridge 222 and the NPAL 214 that supports multiple network protocols and network functions in a network pipeline. The network pipeline includes a set of tables and logic organized in a specific order to be accelerated by the acceleration hardware engine. In at least one embodiment, the virtual bridge 222 can asynchronously receive, from a first thread of the NPAL 214, one or more create requests to create an ECMP group. The virtual bridge 222 can asynchronously create the respective ECMP group in response to each of the one or more create requests. The virtual bridge 222 can receive, from a second thread of the NPAL 214, a first request for acknowledgement for the one or more create requests. The virtual bridge 222 can determine that each of the one or more ECMP groups has been successfully created. The virtual bridge 222 can send, to the second thread, a first acknowledgement in response to the first request for acknowledgement, the first acknowledgement indicating the one or more ECMP groups have been successfully created in the virtual bridge. The second thread of the NPAL 214 can mark the ECMP groups as successfully created. This can be done in an ECMP group table. The ECMP group table can be used to update the routing table 122 used by the network pipeline. The virtual bridge 222 can perform an ECMP operation using at least one of the ECMP groups.

In at least one embodiment, the virtual bridge 222 can asynchronously receive, from the first thread, one or more delete requests to delete an ECMP group. The virtual bridge 222 can asynchronously delete the respective ECMP group in response to each of the one or more delete requests. The virtual bridge 222 can receive, from the second thread, a second request for acknowledgement for the one or more delete requests. The virtual bridge 222 can determine that each of the one or more ECMP groups has been successfully deleted. The virtual bridge 222 can send, to the second thread, a second acknowledgement in response to the second request for acknowledgement, the second acknowledgement indicating the one or more ECMP groups have been successfully deleted. The virtual bridge 222 can perform an ECMP operation using at least one of the ECMP groups.

In at least one embodiment, the virtual bridge 222 can asynchronously receive, from the first thread, one or more additional create requests to create an additional ECMP group. The virtual bridge 222 can receive, from the second thread, a second request for acknowledgement for the one or more additional create requests. The virtual bridge 222 can determine that a group creation of at least one of the additional ECMP groups has failed. The virtual bridge 222 can send, to the first thread, a notification indicating the group creation has failed. The virtual bridge 222 can perform an ECMP operation using at least one of the ECMP groups.

In at least one embodiment, the virtual bridge 222 and NPAL 214 can perform other operations described herein, such as those described with respect to fast link recovery.

The integration of a DPU 204 into the network 210 and the host device 202 thus represents a powerful approach to optimizing data processing tasks, significantly enhancing the performance, and security of data center and cloud computing environments. By handling a substantial portion of the networking, storage, and security workload, the DPU 204 can enable CPUs to focus more on application processing, improving overall system efficiency and throughput. For example, the DPU 204 can handle network data path processing of network traffic data 212. The CPU can control path initialization and exception processing. The DPU 204 can be part of a data center and include one or more data stores, one or more server machines, and other components of data center infrastructure. It should be noted that, unlike a CPU or a GPU, the DPU 204 is a new class of programmable processor that combines three key elements, including, for example: 1) an industry-standard, high-performance, software-programmable CPU (single-core or multi-core CPU), tightly coupled to the other SoC components; 2) a high-performance network interface capable of parsing, processing and efficiently transferring data at line rate, or the speed of the rest of the network, to GPUs and CPUs; and 3) a rich set of flexible and programmable acceleration engines that offload and improve applications performance for AI and machine learning, security, telecommunications, and storage, among others. These capabilities can enable an isolated, bare-metal, cloud-native computing platform for cloud-scale computing. In at least one embodiment, DPU 204 can be used as a stand-alone embedded processor. In at least one embodiment, DPU 204 can be incorporated into a network interface controller (also called a Smart Network Interface Card (SmartNIC)) used as a server system component. A DPU-based network interface card (network adapter) can offload processing tasks that the server system's CPU normally handles. Using its processor, a DPU-based SmartNIC may be able to perform any combination of encryption/decryption, firewall, transport control protocol/Internet Protocol (TCP/IP), and HyperText Transport Protocol (HTTP) processing. SmartNICs can be used for high-traffic web servers, for example.

In at least one embodiment, DPU 204 can be configured for traditional enterprises' modern cloud workloads and high-performance computing. In at least one embodiment, DPU 204 can deliver a set of software-defined networking, storage, security, and management services at a data-center scale with the ability to offload, accelerate, and isolate data center infrastructure. In at least one embodiment, DPU 204 can provide multi-tenant, cloud-native environments with these software services. In at least one embodiment, DPU 204 can deliver data center services of up to hundreds of CPU cores, freeing up valuable CPU cycles to run business-critical applications. In at least one embodiment, DPU 204 can be considered a new type of processor that is designed to process data center infrastructure software to offload and accelerate the compute load of virtualization, networking, storage, security, cloud-native AI/ML services, and other management services.

In at least one embodiment, the DPU 204 can include connectivity with packet-based interconnects (e.g., Ethernet), switched-fabric interconnects (e.g., InfiniBand, Fibre Channels, Omni-Path), or the like. In at least one embodiment, DPU 204 can provide a data center that is accelerated, fully programmable, and configured with security (e.g., zero-trust security) to prevent data breaches and cyberattacks. In at least one embodiment, the DPU 204 can include a network adapter, an array of processor cores, and infrastructure offload engines with full software programmability. In at least one embodiment, the DPU 204 can sit at an edge of a server to provide flexible, secure, high-performance cloud and AI workloads. In at least one embodiment, the DPU 204 can reduce the total cost of ownership and increase data center efficiency. In at least one embodiment, the DPU 204 can provide the software framework and acceleration libraries (e.g., NVIDIA DOCA™) that enable developers to rapidly create applications and services for the DPU 204, such as security services, virtualization services, networking services, storage services, AI/ML services, and management services. In at least one embodiment, the software framework and acceleration libraries make it easy to leverage hardware accelerators of the DPU 204 to provide data center performance, efficiency, and security. In at least one embodiment, the DPU 204 can be coupled to a GPU. The GPU can include one or more accelerated AI/ML pipelines.

In at least one embodiment, the DPU 204 can provide networking services with a virtual switch (vSwitch), a virtual router (vRouter), network address translation (NAT), load balancing, and network virtualization (NFV). In at least one embodiment, the DPU 204 can provide storage services, including NVME™ over fabrics (NVMe-oF™) technology, elastic storage virtualization, hyper-converged infrastructure (HCI) encryption, data integrity, compression, data deduplication, or the like. NVM Express™ is an open logical device interface specification for accessing non-volatile storage media attached via the Peripheral Component Interconnect Express® (PCIe) interface. NVMe-oF™ provides an efficient mapping of NVMe commands to several network transport protocols, enabling one computer (an “initiator”) to access block-level storage devices attached to another computer (a “target”) very efficiently and with minimum latency. The term “Fabric” is a generalization of the more specific ideas of network and input/output (I/O) channel. It essentially refers to an N:M interconnection of elements, often in a peripheral context. The NVMe-oF™ technology enables the transport of the NVMe command set over a variety of interconnection infrastructures, including networks (e.g., Internet Protocol (IP)/Ethernet) and I/O Channels (e.g., Fibre Channel). In at least one embodiment, the DPU 204 can provide hardware-accelerated services using Next-Generation Firewall (NGFW), Intrusion Detection Systems (IDS), Intrusion Prevention System (IPS), a root of trust, micro-segmentation, distributed denial-of-service (DDoS) prevention technologies, and ML detection. NGFW is a network security device that provides capabilities beyond a stateful firewall, like application awareness and control, integrated intrusion prevention, and cloud-delivered threat intelligence. In at least one embodiment, one or more network interfaces can include an Ethernet interface (single or dual ports) and an InfiniBand interface (single or dual ports). In at least one embodiment, the one or more host interfaces can include a PCIe interface and a PCIe switch. In at least one embodiment, the one or more host interfaces can include other memory interfaces. In at least one embodiment, the CPU can include multiple cores (e.g., up to 8 64-bit core pipelines) with L2 cache per two one or two cores and L3 cache with eviction policies support for double data rate (DDR) dual in-line memory module (DIMM) (e.g., Double Data Rate 4 (DDR4) DIMM support), and a DDR4 Dynamic Random Access Memory (DRAM) controller. Memory can be on-board DDR4 memory with error correction code (ECC) error protection support. In at least one embodiment, the CPU can include a single core with L2 and L3 caches and a DRAM controller. In at least one embodiment, the one or more hardware accelerators can include a security accelerator, a storage accelerator, and a networking accelerator. In at least one embodiment, the security accelerator can provide a secure boot with hardware root-of-trust, secure firmware updates, Cerberus compliance, Regular expression (RegEx) acceleration, IP security (IPsec)/Transport Layer Security (TLS) data-in-motion encryption, Advanced Encryption Standard Galois/Counter Mode (AES-GCM) 512/256-bit key for data-at-rest encryption (e.g., AES with ciphertext stealing (XTS) (e.g., AES-XTS 256/512), secure hash algorithm (SHA) 256-bit hardware acceleration, Hardware public key accelerator (e.g., Rivest-Shamir-Adleman (RSA), Diffie-Hellman, Digital Signal Algorithm (DSA), ECC, Elliptic Curve Cryptography Digital Signal Algorithm (ECC-DSA), Elliptic-curve Diffie-Hellman (EC-DH)), and True random number generator (TRNG). In at least one embodiment, the storage accelerator can provide BlueField SNAP-NVMe™ and VirtIO-blk, NVMe-oF™ acceleration, compression and decompression acceleration, and data hashing and deduplication. In at least one embodiment, the network accelerator can provide remote direct memory access (RDMA) over Converged Ethernet (RoCE) RoCE, Zero Touch RoCE, Stateless offloads for TCP, IP, and User Datagram Protocol (UDP), Large Receive Offload (LRO), Large Segment Offload (LSO), checksum, Total Sum of Squares (TSS), Residual Sum of Squares (RSS), HTTP dynamic streaming (HDS), and virtual local area network (VLAN) insertion/stripping, single root I/O virtualization (SR-IOV), virtual Ethernet card (e.g., VirtIO-net), Multi-function per port, VMware NetQueue support, Virtualization hierarchies, and ingress and egress Quality of Service (QoS) levels (e.g., 1K ingress and egress QoS levels). In at least one embodiment, the DPU 204 can also provide boot options, including secure boot (RSA authenticated), remote boot over Ethernet, remote boot over Internet Small Computer System Interface (iSCSI), Preboot execution environment (PXE), and Unified Extensible Firmware Interface (UEFI).

In at least one embodiment, the DPU 204 can provide management services, including a 1GbE out-of-band management port, network controller sideband interface (NC-SI), Management Component Transport Protocol (MCTP) over System Management Bus (SMBus), and Monitoring Control Table (MCT) over PCIe, Platform Level Data Model (PLDM) for Monitor and Control, PLDM for Firmware Updates, Inter-Integrated Circuit (I2C) interface for device control and configuration, Serial Peripheral Interface (SPI) interface to flash, embedded multi-media card (eMMC) memory controller, Universal Asynchronous Receiver/Transmitter (UART), and Universal Serial Bus (USB).

The host device 202 may be a desktop computer, a laptop computer, a smartphone, a tablet computer, a server, or any suitable computing device capable of performing the techniques described herein. In some embodiments, the host device 202 may be a computing device of a cloud-computing platform. For example, the host device 202 may be a server machine of a cloud-computing platform or a component of the server machine. In such embodiments, the host device 202 may be coupled to one or more edge devices (not shown) via the network 210. An edge device refers to a computing device that enables communication between computing devices at the boundary of two networks. For example, an edge device may be connected to host device 202, one or more data stores, one or more server machines via network 210, and may be connected to one or more endpoint devices (not shown) via another network. In such an example, the edge device can enable communication between the host device 202, one or more data stores, one or more server machines, and one or more client devices. In other or similar embodiments, host device 202 may be an edge device or a component of an edge device. For example, host device 202 may facilitate communication between one or more data stores, one or more server machines connected to host device 202 via network 210, and one or more client devices connected to host device 202 via another network.

In still other or similar embodiments, the host device 202 can be an endpoint device or a component of an endpoint device. For example, host device 202 may be, or may be a component of, devices, such as televisions, smartphones, cellular telephones, data center servers, data DPUs, personal digital assistants (PDAs), portable media players, netbooks, laptop computers, electronic book readers, tablet computers, desktop computers, set-top boxes, gaming consoles, a computing device for autonomous vehicles, a surveillance device, and the like. In such embodiments, host device 202 may be connected to the DPU 204 over one or more network interfaces via network 210. In other or similar embodiments, host device 202 may be connected to an edge device (not shown) via another network, and the edge device may be connected to the DPU 204 via network 210.

In at least one embodiment, the host device 202 executes one or more computer programs. One or more computer programs can be any process, routine, or code executed by the host device 202, such as a host OS, an application, a guest OS of a virtual machine, or a guest application, such as executed in a container. host device 202 can include one or more CPUs of one or more cores, one or more multi-core CPUs, one or more GPUs, one or more hardware accelerators, or the like.

In at least one embodiment, the DPU 204 provides the virtual bridge 222 and the NPAL 214 to provide ECMP optimizations for creating and deleting ECMP groups. An example software stack of the DPU 204 is illustrated and described below with respect to FIG. 3.

FIG. 3 is a block diagram of a software stack 300 of a DPU with an NPAL 302 with ECMP optimization according to at least one embodiment. As described above, to support fast link recovery, the DPU needs to support it in both hardware and software. From the hardware perspective, the DPU hardware includes a network interconnect coupled to a network, a host interconnect coupled to a host device, and an acceleration hardware engine. The DPU hardware can include additional hardware, such as a processing device (e.g., one or more CPU cores), one or more GPUs, switches, memory, or the like.

From the software perspective, the software stack 300 can support ECMP optimization for creating/deleting ECMP groups and fast link recovery. The software stack 300 can be stored in a memory of the DPU. The software stack 300 includes firmware 306, driver 308, virtual bridge 310, and NPAL 302. The firmware 306 can interact with the DPU hardware 304 and the driver 308. The driver 308 can interact with the firmware 306 and the virtual bridge 310. The NPAL 302 can sit on top of the virtual bridge 310. The software stack 300 can be made up of instructions that when executed by the DPU hardware can provide the NPAL 302 that supports multiple network protocols and network functions in a network pipeline. As described above, the network pipeline includes a set of tables and logic organized in a specific order to be accelerated by the acceleration hardware engine.

In at least one embodiment, the NPAL 302 includes ECMP logic 314. The ECMP logic 314 can create an ECMP group (e.g., group 0, group 1, etc.). Each ECMP group can include a group of identifiers (e.g., txid=0, txid=1, etc.). These group of identifiers can be used in a routing table 318. A user can configure a new ECMP group using the NPAL 302. In particular, the ECMP logic 314 can asynchronously send create requests to the virtual bridge 310. The ECMP logic 314 can send a request for acknowledgement (e.g., a barrier) to the virtual bridge 310 to confirm that a batch of one or more ECMP groups has been successfully created. In response the virtual bridge 310 can send an acknowledgement (e.g., all requests up to txid=0 OK). The barrier or other request for acknowledgement can be used to return acknowledgement for successful group creation. In response to one of the ECMP groups not being successfully created, the virtual bridge 310 can send the ECMP logic 314 a notification of the failure. Similarly, the ECMP logic 314 can delete an ECMP group. A user can delete a new ECMP group using the NPAL 302. In particular, the ECMP logic 314 can asynchronously send requests delete requests to the virtual bridge 310. Similarly, the ECMP logic 314 can send a request for acknowledgement (e.g., a barrier) to the virtual bridge 310 to confirm that a batch of one or more ECMP groups has been successfully deleted. The barrier or other request for acknowledgement can be used to return acknowledgement for successful group deletion. In response to one of the ECMP groups not being successfully deleted, the virtual bridge 310 can send the ECMP logic 314 a notification of the failure.

In at least one embodiment, the virtual bridge 310 can include link monitoring logic 312 that monitors a link availability of each of a plurality of links to a destination. The plurality of links can be part or specified in an initial group of identifiers in a routing table 318. That is, the link monitoring logic 312 can monitor if a link is available by monitoring all ports associated with the initial group of link identifiers. The link monitoring logic 312 can detect a link failure of a first link of the plurality of links. The link monitoring logic 312 can notify ECMP logic 314 in the NPAL 302. The ECMP logic 314 can remove a first link identifier, associated with the first link, from the initial group of link identifiers to obtain a modified group of link identifiers in an ECMP group table 316. The ECMP logic 314 can also cause a routing table 318 in the NPAL 302 to be updated to remove the first link identifier. The acceleration hardware engine in the DPU hardware 304 can process network traffic data using the network pipeline and distribute the network traffic data to only the remaining links of the plurality of links corresponding to the modified group of identifiers.

In at least one embodiment, the virtual switch is controlled by a network service hosted on the DPU. The virtual switch can send a notification to the network service of the link failure of the first link. The network service can update the routing table in the NPAL in response to the notification. The routing table stores configuration information associated with the initial group of identifiers. In at least one embodiment, the notification is a message from a kernel (e.g., NetLink message from a Linux kernel).

In at least one embodiment, the ECMP logic 314 can receive a first packet prior to the link failure of the first link, and perform an IP address lookup for the first packet to identify an ECMP group identifier associated with the plurality of links. The ECMP logic 314 can hash the ECMP group identifier to identify any one of the plurality of links. The ECMP logic 314 can receive a second packet after the link failure of the first link, and perform an IP address lookup for the second packet to identify the ECMP group identifier. The ECMP logic 314 can hash the ECMP group identifier to identify any one of the remaining links.

In at least one embodiment, the virtual bridge 310 can monitor the link availability of each of the plurality of links to the destination, and detect a link recovery of the first link. The ECMP logic 314 can add the first link identifier to the modified group of link identifiers to obtain the initial group of link identifiers in the ECMP group table 316. The ECMP logic 314 can cause the routing table 318 in the NPAL 302 to be updated to add the first link identifier. The acceleration hardware engine is to process subsequent network traffic data using the network pipeline and distribute the subsequent network traffic data to the plurality of links corresponding to the initial group of identifiers. In at least one embodiment, the ECMP logic 314 can receive a first packet prior to the link recovery of the first link, and perform an IP address lookup for the first packet to identify an ECMP group identifier associated with the plurality of links. The ECMP logic 314 can hash the ECMP group identifier to identify any one of the remaining links. The ECMP logic 314 can receive a second packet after the link recovery of the first link, and perform an IP address lookup for the second packet to identify the ECMP group identifier. The ECMP logic 314 can hash the ECMP group identifier to identify any one of the plurality of links.

In at least one embodiment, the virtual bridge 310 is controlled by the NPAL 302 (or a network service) hosted on the DPU. The virtual bridge 310 can send a first notification to the NPAL 302 of the link failure of the first link. The NPAL 302 can update the routing table 318 in the NPAL 302 in response to the first notification, the routing table storing configuration information associated with the initial group of identifiers. The virtual bridge 310 can send a second notification to the NPAL 302 of the link recovery of the first link. The NPAL 302 can update the routing table 318 in the NPAL 302 in response to the second notification. In at least one embodiment, the virtual bridge 310 can remove the first link identifier from the ECMP group in the virtual bridge 310, and modify the routing table 318 in the NPAL 302 in parallel.

In at least one embodiment, the network pipeline includes an input port, an ingress dynamic or static ACL, a bridge, a router, and egress dynamic or static ACL, and an output port. The routing table 318 can be stored in the bridge, the router, or both. An example network pipeline is illustrated and described below with respect to FIG. 6, FIG. 8, and FIG. 9.

As described above, the ECMP logic 314 can operate in a synchronous mode illustrated and described below with respect to FIG. 4, or an asynchronous mode illustrated and described below with respect to FIG. 5.

FIG. 4 is a sequence diagram of an ECMP group creation operation 400 in a synchronous mode according to at least one embodiment. In the synchronous mode, a single thread 402 of the NPAL sends a create request 406 (also referred to as “add” request) to a virtual bridge 404 (e.g., add group 0 [txid=0,1,2]. The single thread 402 then sends a request for acknowledgement 408 to the virtual bridge 404 to confirm that the group has been successfully created. The request for acknowledgement 408 can be a barrier. If the group has been successfully created, the virtual bridge 404 can send an acknowledgement 410 back to the single thread 402 (e.g., all requests up to txid=2 OK). When another group needs to be created, the single thread 402 can send a create request 412 to the virtual bridge 404 (e.g., add group 1 [txid=3,4,5]). Then, the single thread 402 can send a request for acknowledgement 414 to the virtual bridge 404. If the group is not successful, the virtual bridge 404 can send a notification 416 of the failure (e.g., txid=4 error). Similar operations can be performed when deleting an ECMP group.

In the synchronous mode, every ECMP group creation/deletion gets acknowledged from lower layer software, i.e., virtual bridge 404 (and driver). Since each group is waiting for acknowledgement, using synchronous mode will be slower.

In contrast, in an asynchronous mode, ECMP groups creation/deletion is done in a batch, and an acknowledgement is not sent per group, but per batch of groups. Also, in the asynchronous mode, two threads are used in parallel to perform the creation/deletion operation. In the asynchronous mode, the creation/deletion time is much lower (e.g., up to 94% improvement in speed) as compared to the synchronous mode. Additional details of the asynchronous mode are illustrated and described below with respect to FIG. 5.

FIG. 5 is a sequence diagram of an ECMP group creation operation 500 in an asynchronous mode according to at least one embodiment. In the asynchronous mode, a first thread 502 of the NPAL asynchronously sends a create request 508 (also referred to as “add” request) to a virtual bridge 504 (e.g., add group 0 [txid=0,1,2]). Similarly, the first thread 502 can asynchronously send a create request 510 (e.g., add group 1 [txid=3,4,5]) and a create request 512 (e.g., add group 2 [txid=6,7,8]) to the virtual bridge 504. A second thread 506 of the NPAL sends a request for acknowledgement 514 to the virtual bridge 504 to confirm that a batch of groups has been successfully created. The request for acknowledgement 514 can be a barrier. If the batch of groups has been successfully created, the virtual bridge 504 can send an acknowledgement 516 back to the second thread 506 (e.g., all requests up to txid=8 OK). The second thread 506 can mark groups as successfully created 518 (e.g., mark groups {0,1,2} as successful).

When another group needs to be created, the first thread 502 can asynchronously send a create request 520 (e.g., add group 3 [txid=9,10,11]) and a create request 522 (e.g., add group 4 [txid=12,13,14]) to the virtual bridge 504. The create request 520 and create request 522 can be part of a second batch. Then, the second thread 506 can send a request for acknowledgement 524 to the virtual bridge 504. If the group is not successful, the virtual bridge 504 can send a notification 526 of the failure (e.g., txid=10 error). In at least one embodiment, the virtual bridge 504 can send the notification 526 to the first thread 502. The virtual bridge 504 can send an acknowledgement 530 (e.g., all requests up to txid=14 OK) for a successfully created group in the second batch. The 506 can mark the group as successfully created 532 (e.g., mark group 4 as successful). Similar operations can be performed when deleting ECMP groups in batches.

In the synchronous mode, every batch of ECMP groups creation/deletion is getting acknowledgement from lower layer software, i.e., virtual bridge 504 (and driver). Since ECMP groups creation/deletion is done in a batch, and an acknowledgement is not sent per group, but per batch of groups. Also, in the asynchronous mode, two threads are used in parallel to perform the creation/deletion operation. In the asynchronous mode, the creation/deletion time is much lower (e.g., up to 94% improvement in speed) as compared to the synchronous mode.

FIG. 6 is a network diagram of an example network pipeline 600 that is optimized and accelerated on an acceleration hardware engine of a DPU having an NPAL with ECMP optimization according to at least one embodiment. The network pipeline 600 includes an input port 602, a filtering network function 604, an ingress port 606, a first network function 608, a bridge 610, a Switched Virtual Interface (SVI) ACLs 612, a router 614, a second network function 616, an egress port 618, and an output port 620. The input port 602 can receive the network traffic data and provide the network traffic data to the filtering network function 604, which is operatively coupled to the input port 602. The filtering network function 604 can filter the network traffic data. The ingress port 606 is operatively coupled to the filtering network function 604, and the ingress port 606 is operatively coupled to the first network function 608. The first network function 608 can process the network traffic data using one or more ingress ACLs. The bridge 610 is operatively coupled to the first network function 608. The bridge 610 can perform a Layer-2 (L2) bridging operation. In at least one embodiment, the bridge 610 can perform an ECMP bridge operation using a current routing table 622.

As described herein, the NPAL can perform ECMP group creation/deletion operations and update a routing table 622 that is stored in the bridge 610 or router 614 or both. As described above, the virtual switch can monitor a link availability of each of a plurality of links to a destination. Once the virtual switch detects a link failure of a first link, the virtual switch can remove a first link identifier, associated with the first link, from an initial group of link identifiers to obtain a modified group of link identifiers in the ECMP group table 316. The virtual switch causes the routing table 622 to be updated to remove the first link identifier. Once the routing table 622 is updated, the acceleration hardware engine can process network traffic data using the network pipeline and distribute the network traffic data to only the remaining links of the plurality of links corresponding to the modified group of identifiers. Similarly, the virtual switch can continue monitoring the link availability of each link. The virtual switch can detect a link recovery of the first link. The virtual switch can add the first link identifier to the modified group of link identifiers to obtain the initial group of link identifiers, and cause the routing table 622 to be updated to add the first link identifier. Once the routing table 622 is updated, the acceleration hardware engine can process subsequent network traffic data using the network pipeline and distribute the subsequent network traffic data to the plurality of links corresponding to the initial group of identifiers.

The one or more SVI ACLs are operatively coupled to the bridge 610 and the router 614. The router 614 can perform an ECMP routing operation using the current routing table 622, excluding any failed links as described above. The second network function 616 is operatively coupled to the router 614, The second network function 616 can process the network traffic data using one or more egress ACLs. The egress port 618 is operatively coupled to the second network function 616. The egress port 618 is operatively coupled to the output port 620. The output port 620 can output the network traffic data.

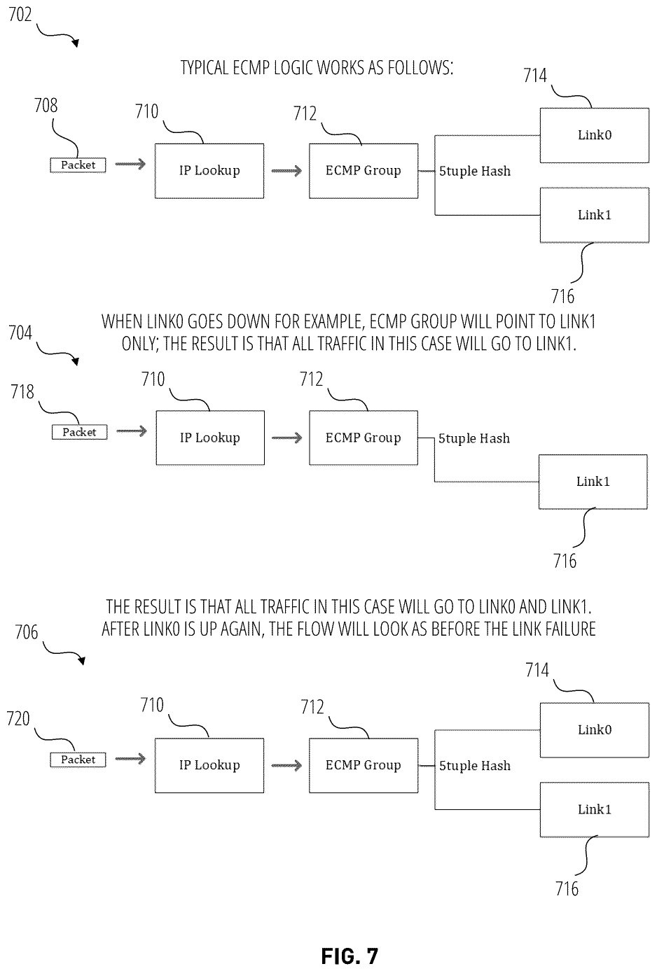

As described above, the NPAL (or virtual bridge) can include ECMP logic 102 that performs ECMP operations on incoming packets before a link failure, after a link failure, and after a link recovery, such as illustrated and described below with respect to FIG. 7.

FIG. 7 are flow diagrams of ECMP operations before a link failure, after a link failure, and after a link recovery according to at least one embodiment. In a first flow 702, the ECMP logic receives a first packet 708 and performs an IP lookup operation 710 that returns an ECMP group 712. The ECMP group 712 can be a 5tuple hash that identifies a first link 714 (Link0) and a second link 716 (Link1) as part of the ECMP group 712. The first flow 702 is before a link failure is detected.

In a second flow 704, if a link failure is detected for the first link 714, the ECMP logic receives a second packet 718 and performs the IP lookup operation that returns the ECMP group 712. The 5tuple hash of the ECMP group 712 in this instance identifies only the second link 716, since the first link 714 has a link failure. The result is that all traffic in this case will go to only the second link 716 (Link1). The second flow 704 is after a link failure is detected.

In a third flow 706, if a link recovery is detected for the first link 714, the ECMP logic receives a third packet 720 and performs the IP lookup operation 710 that returns the ECMP group 712. In this instances, the ECMP group 712 can be a 5tuple hash that identifies the first link 714 (Link0) and the second link 716 (Link1) as part of the ECMP group 712. The result is that all traffic in this case will go to both the first link 714 (Link0) and the second link 716 (Link1). The third flow 706 is after a link recovery is detected.

FIG. 8 is a network diagram of an example network pipeline that is optimized and accelerated on an acceleration hardware engine of a DPU having an NPAL according to at least one embodiment. The network pipeline 800 includes an input port 802, a filtering network function 804, an ingress port with first network function 806, a second network function 808, a bridge 810, an SVI ACLs 812, a router 814, a third network function 816, an egress port with a fourth network function 818, and an output port 820. The input port 802 can receive the network traffic data and provide the network traffic data to the filtering network function 804, which is operatively coupled to the input port 802 with a first filtering network function 804. The filtering network function 804 can filter the network traffic data, providing the network traffic data to the ingress port with the first network function 806. The first network function 806 can perform first virtual local area network (VLAN) mapping on the network traffic data and provide the data to the second network function 808 (or alternatively, the bridge 810). The second network function can process the network traffic data using one or more ingress Access Control Lists (ACLs). The ingress ACLs can be dynamic or static ACLs. The bridge 810 is operatively coupled to the first network function and the second network function 808. The bridge 810 can perform a Layer-2 (L2) bridging operation. In at least one embodiment, the bridge 810 can perform ECMP operations using the routing table 622. The SVI ACLs are operatively coupled to the bridge 810 and the router 814. The router 814 can perform a Layer-3 (L3) routing operation. In at least one embodiment, the router 814 can perform ECMP operations using the routing table 622. The third network function 816 is operatively coupled to the router 814. The third network function 816 can process the network traffic data using one or more egress ACLs. The egress ACLs can be dynamic or static. The egress port with fourth network function 818 is operatively coupled to the third network function 816. The fourth network function can perform a second VLAN mapping on the network traffic data. The output port 820 is operatively coupled to the egress port with the fourth network function 418. The output port 820 can output the network traffic data.

FIG. 9 is a network diagram of an example network pipeline 900 that is optimized and accelerated on an acceleration hardware engine of a DPU having an NPAL according to at least one embodiment. The network pipeline 900 includes an input port 902, a first network function 904, a second network function 906, a third network function 908, a fourth network function 910, a fifth network function 912, a sixth network function 914, a seventh network function 916, and an output port 918. In at least one embodiment, the first network function 904 includes the ECMP logic 102 as described herein. The network pipeline 900 can include any combination of network functions in a specified order, each network function including logic and/or tables to implement the respective network function and pass the network traffic data to the subsequent network function. In at least one embodiment, the first network function 904 can perform Layer-2 (L2) bridging, the second network function 906 can perform Layer-3 (L3) routing, the third network function 908 can perform tunnel encapsulation or tunnel decapsulation, the fourth network function 910 can perform a hash calculation, the fifth network function 912 can perform an ECMP operation, the sixth network function 914 can perform a CT operation, and the seventh network function 916 can perform a NAT operation. In at least one embodiment, the fifth network function 912 can use the routing table 622. Alternatively, the network pipeline 900 can include different numbers and different types of network operations between the input port 902 and output port 918.

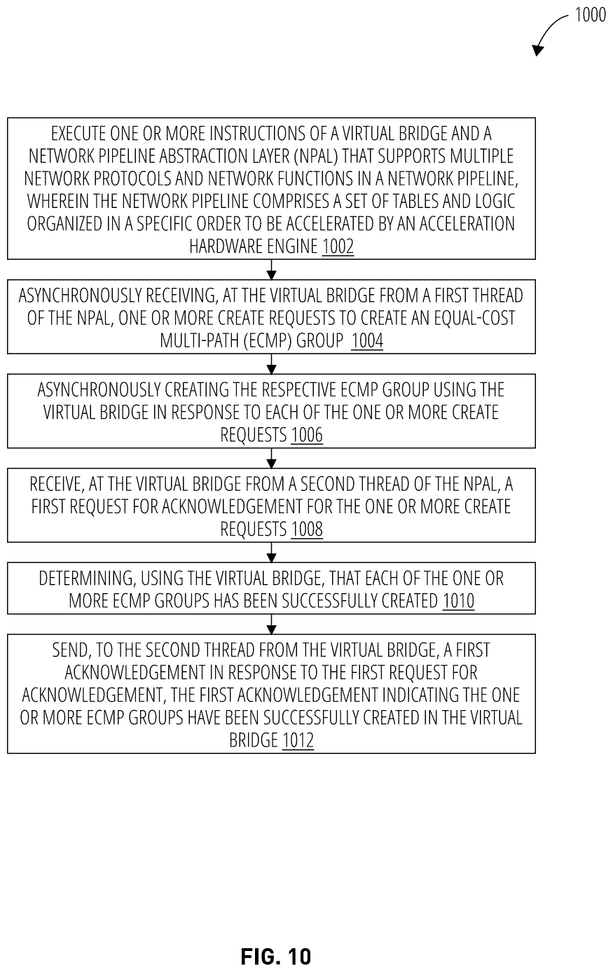

FIG. 10 is a flow diagram of a method 1000 of operating a DPU with ECMP optimization according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 1000 may be performed by multiple processing threads, each thread executing one or more individual functions, routines, subroutines, or operations of the method. In at least one embodiment, processing threads implementing method 1000 may be synchronized (e.g., using semaphores, critical sections, and/or other thread synchronization logic). Alternatively, processing threads implementing method 1000 may be executed asynchronously with respect to each other. Various operations of method 1000 may be performed differently than the order shown in FIG. 10. Some operations of the methods may be performed concurrently with other operations. In at least one embodiment, one or more operations shown in FIG. 10 may not always be performed. In at least one embodiment, the method 1000 is performed by the integrated circuit 100, processing device 108, or ECMP logic 102 of FIG. 1. In at least one embodiment, the method 1000 is performed by the computing system 200, DPU 204, DPU hardware 208, of FIG. 2. integrated circuit 100, processing device 108, or ECMP logic 102 of FIG. 1. In at least one embodiment, the method 1000 is performed by the network pipeline 600 of FIG. 6, the network pipeline 800 of FIG. 8, or the network pipeline 900 of FIG. 9.

Referring to FIG. 10, the method 1000 begins with the processing logic executing one or more instructions of a virtual bridge and a NPAL that supports multiple network protocols and network functions in a network pipeline (block 1002). The network pipeline includes a set of tables and logic organized in a specific order to be accelerated by an acceleration hardware engine. At block 1004, the processing logic asynchronously receives, at the virtual bridge from a first thread of the NPAL, one or more create requests to create an Equal-Cost Multi-Path (ECMP) group. At block 1006, the processing logic asynchronously creates the respective ECMP group using the virtual bridge in response to each of the one or more create requests. At block 1008, the processing logic receives, at the virtual bridge from a second thread of the NPAL, a first request for acknowledgement for the one or more create requests. At block 1010, the processing logic determines, using the virtual bridge, that each of the one or more ECMP groups has been successfully created. At block 1012, the processing logic sends, to the second thread from the virtual bridge, a first acknowledgement in response to the first request for acknowledgement, the first acknowledgement indicating the one or more ECMP groups have been successfully created in the virtual bridge.

In a further embodiment, the processing logic asynchronously receives at the virtual bridge from the first thread, one or more delete requests to delete an ECMP group. The processing logic asynchronously deletes the respective ECMP group using the virtual bridge in response to each of the one or more delete requests. The processing logic receives, at the virtual bridge from the second thread, a second request for acknowledgement for the one or more delete requests. The processing logic determines that each of the one or more ECMP groups has been successfully deleted. The processing logic sends to the second thread from the virtual bridge, a second acknowledgement in response to the second request for acknowledgement, the second acknowledgement indicating the one or more ECMP groups have been successfully deleted.

In a further embodiment, the processing logic asynchronously receives, at the virtual bridge from the first thread, one or more additional create requests to create an additional ECMP group. The processing logic receives, at the virtual bridge from the second thread, a second request for acknowledgement for the one or more additional create requests. The processing logic determines, using the virtual bridge, that a group creation of at least one of the additional ECMP groups has failed. The processing logic sends, to the first thread from the virtual bridge, a notification indicating the group creation has failed.

In a further embodiment, the processing logic monitors, using the virtual bridge, a link availability of each of a plurality of links to a destination, the plurality of links being specified in an initial group of identifiers of an ECMP group. The processing logic detects, using the virtual bridge, a link failure of a first link of the plurality of links. The processing logic removes, using the NPAL, a first link identifier, associated with the first link, from the initial group of link identifiers to obtain a modified group of link identifiers. The processing logic updates, using the NPAL, a routing table to remove the first link identifier. The processing logic processes, using the acceleration hardware engine, network traffic data using the network pipeline. The processing logic distributes the network traffic data to only the remaining links of the plurality of links corresponding to the modified group of identifiers.

In a further embodiment, the processing logic receives a first packet prior to the link failure of the first link. The processing logic performs an IP address lookup for the first packet to identify an ECMP group identifier associated with the plurality of links. The processing logic hashes the ECMP group identifier to identify any one of the plurality of links. The processing logic receives a second packet after the link failure of the first link. The processing logic performs an IP address lookup for the second packet to identify the ECMP group identifier. The processing logic hashes the ECMP group identifier to identify any one of the remaining links.

In a further embodiment, the processing logic monitors, using the virtual bridge, a link availability of each of a plurality of links to a destination, the plurality of links being specified in an initial group of identifiers of an ECMP group. The processing logic detects a link recovery of the first link. The processing logic adds the first link identifier to the modified group of link identifiers to obtain the initial group of link identifiers. The processing logic causes the routing table in the NPAL to be updated to add the first link identifier. The processing logic processes, using the acceleration hardware engine, subsequent network traffic data using the network pipeline. The processing logic distributes the subsequent network traffic data to the plurality of links corresponding to the initial group of identifiers.

In a further embodiment, the processing logic receives a first packet prior to the link recovery of the first link. The processing logic performs an Internet Protocol (IP) address lookup for the first packet to identify an ECMP group identifier associated with the plurality of links. The processing logic hashes the ECMP group identifier to identify any one of the remaining links. The processing logic receives a second packet after the link recovery of the first link. The processing logic performs an IP address lookup for the second packet to identify the ECMP group identifier. The processing logic hashes the ECMP group identifier to identify any one of the plurality of links.

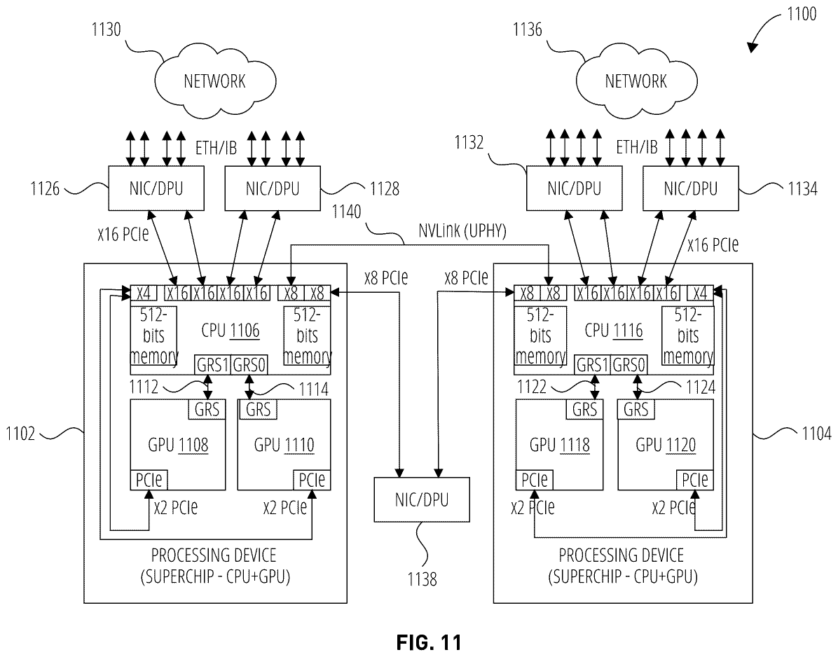

FIG. 11 is a block diagram of a computing system 1100 having two processing devices coupled to each other and multiple networks according to at least one embodiment. The computing system 1100 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 1100. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 1100 highly suitable for demanding applications that require significant processing power, such as artificial intelligence (AI), machine learning (ML), and data-intensive computing, while ensuring robust connectivity and scalability across various networked environments. The integrated circuits of the computing system 1100 can include one or more CPUs and one or more GPUs. An example architecture of a multi-GPU architecture is illustrated in FIG. 11.

As illustrated in FIG. 11, the computing system 1100 includes a processing device 1102 with a multi-GPU architecture. In particular, the processing device 1102 includes a CPU 1106, a GPU 1108, and a GPU 1110. The CPU 1106 can be coupled to the GPU 1108 via an die-to-die (D2D) or chip-to-chip (C2C) interconnect 1112, such as a Ground-Referenced Signaling interconnect (GRS interconnect). The CPU 1106 can be coupled to the GPU 1110 via a D2D or C2C interconnect 1114. The CPU 1106 can also be coupled to the GPU 1108 and GPU 1110 via PCIe interconnects. The CPU 1106 can be coupled to one or more network interface cards (NICs) or data processing units (DPUs), which are coupled to one or more networks. For example, as illustrated in FIG. 11, the CPU 1106 is coupled to a first NIC/DPU 1126, which is coupled to a network 1130. The CPU 1106 is also coupled to a second NIC/DPU 1128, which is coupled to the network 1130. The NIC/DPU 1126 and NIC/DPU 1128 can be coupled to the network 1130 over Ethernet (ETH) or InfiniBand (IB) connections.

The computing system 1100 also includes a processing device 1104 with a multi-GPU architecture. In particular, the processing device 1104 includes a CPU 1116, a GPU 1118, and a GPU 1120. The CPU 1116 can be coupled to the GPU 1118 via an D2D or C2C interconnect 1122. The CPU 1116 can be coupled to the GPU 1120 via a D2D or C2C interconnect 1124. The CPU 1116 can also be coupled to the GPU 1118 and GPU 1120 via PCIe interconnects. The CPU 1116 can be coupled to one or more NICs or DPUs, which are coupled to one or more networks. For example, as illustrated in FIG. 11, the CPU 1116 is coupled to a first NIC/DPU 1132, which is coupled to a network 1136. The CPU 1116 is also coupled to a second NIC/DPU 1134, which is coupled to the network 1136. The NIC/DPU 1132 and NIC/DPU 1134 can be coupled to the network 1136 over Ethernet (ETH) or InfiniBand (IB) connections.

In at least one embodiment, the processing device 1102 and the processing device 1104 can communicate with each other via a NIC/DPU 1138, such as over PCIe interconnects. The processing device 1102 and processing device 1104 can also communicate with each other over a high-bandwidth communication interconnects 1140, such as an NVLink interconnect or other high-speed interconnects.

The NIC/DPUs of FIG. 11 can be the various embodiments of the DPUs described herein with respect to FIG. 1 to FIG. 10.

In at least one embodiment, the computing system 1100 is used for high-speed network communication and includes a processing unit (e.g., CPU 1106, GPU 1108, GPU 1110, CPU 1116, GPU 1118, GPU 1120, NIC/DPU 1126, NIC/DPU 1128, NIC/DPU 1132, NIC/DPU 1134, or NIC/DPU 1138), and a network interface coupled to the processing unit. The network interface can include the operations and functionality of the DPUs described herein.

In at least one embodiment, the computing system 1100 includes a host device and an auxiliary device. The auxiliary device includes a device memory and a processor, communicably coupled to the device memory. The auxiliary device performs the operations described herein with respect to FIG. 1 to FIG. 10. The auxiliary device can include a GPU. The auxiliary device can include a DPU. The auxiliary device can include a DPU. The auxiliary device can include accelerator hardware.

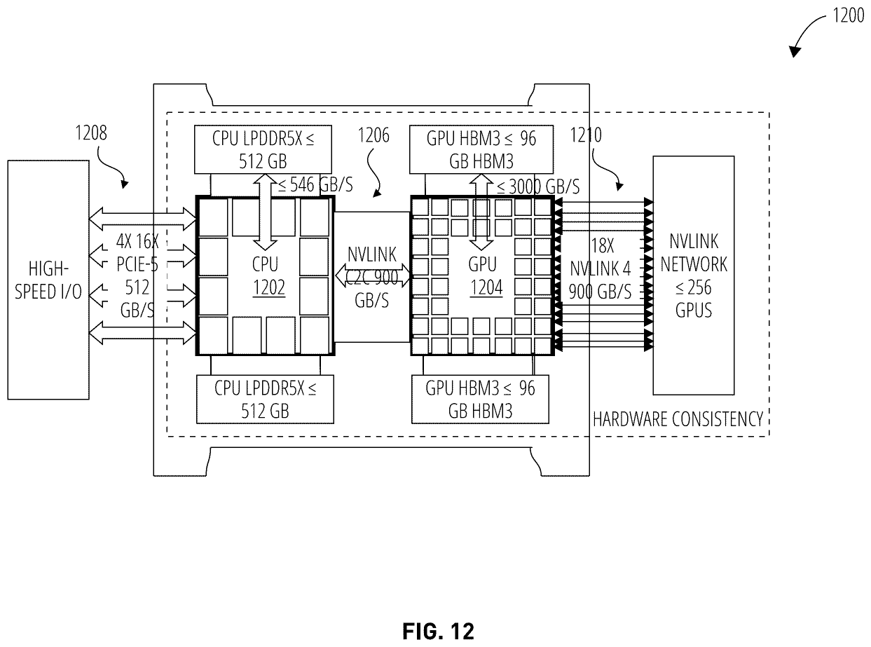

FIG. 12 is a block diagram of a computing system 1200 having a CPU 1202 and a GPU 1204 in a single integrated circuit according to at least one embodiment. The computing system 1200 can be a highly integrated design where a CPU 1202 and GPU 1204 are connected on a single integrated circuit, utilizing an NVLink C2C (Chip-to-Chip) interconnect 1206 to enable fast, low-latency communication between the two processing units. This close integration allows for efficient data transfer and parallel processing between the CPU 1202 and GPU 1204, optimizing performance for complex computational tasks. The GPU elements within the computing system 1200 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1210. Additionally, the computing system 1200 can be designed to interface with a high-speed I/O through PCIe interconnects 1208, ensuring rapid data transfer to and from external devices, further enhancing the system's capabilities in handling data-intensive tasks and providing robust connectivity to peripheral components. It should be noted that the C2C interconnects 1206 can be considered D2D interconnects since the CPU 1202 and the GPU 1204 are located on the same integrated circuit. The integrated circuit can include CPU memory (also referred to as main memory) and GPU memory, which are accessible by the CPU 1202 and the GPU 1204, respectively, over high-speed interconnects. The computing system 1200 can bring together performance of the GPU 1204 with the versatility of the CPU 1202. The CPU 1202 can be connected with a high-bandwidth and memory coherent C2C interconnects 1206 in a single integrated circuit. The computing system 1200 can support a link switch system.

The computing system 1200 can be used for the various embodiments described herein with respect to FIG. 1 to FIG. 11.

In at least one embodiment, the computing system 1200 is used for high-speed network communication and includes a processing unit, and a network interface coupled to the processing unit. The network interface can include the operations and functionality of the DPUs described herein.

In at least one embodiment, the computing system 1200 includes a host device and an auxiliary device. The auxiliary device includes a device memory and a processor, communicably coupled to the device memory. The auxiliary device performs the operations described herein with respect to FIG. 1 to FIG. 11. The auxiliary device can include a GPU. The auxiliary device can include a DPU. The auxiliary device can include a DPU. The auxiliary device can include accelerator hardware.

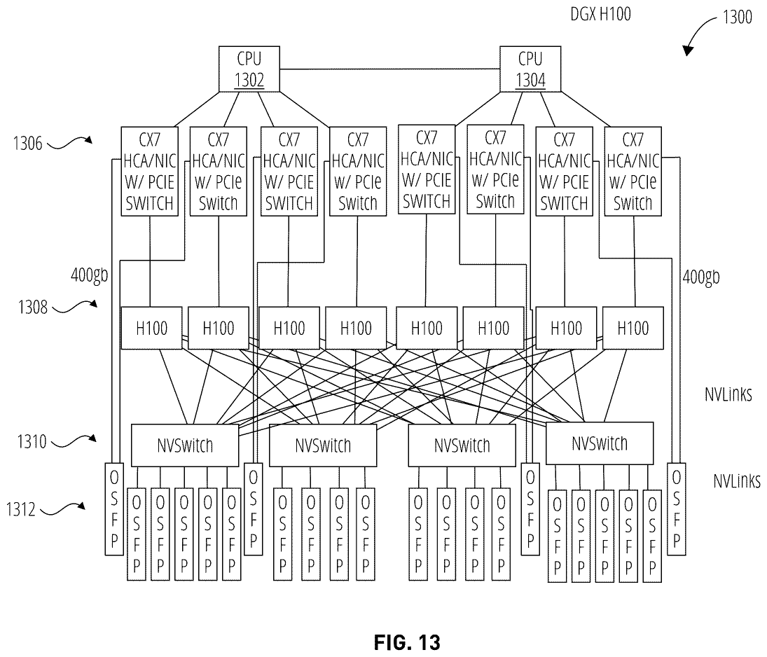

FIG. 13 is a block diagram of a computing system 1300 having tensor core GPUs 1308 according to at least one embodiment. The computing system 1300 can be a DGX H100 system, which is a high-performance computing platform designed to meet the demands of AI, ML, and deep learning (DL) workloads. The computing system 1300 can include multiple tensor core GPUs 1308 (e.g., NVIDIA H100 Tensor Core GPUs). The tensor core GPUs 1308 can each be one of the integrated circuits described above with respect to FIG. 12. The tensor core GPUs 1308 can be optimized for AI/ML/DL applications, offering exceptional performance for deep learning training, inference, and high-performance computing tasks. The tensor core GPUs 1308 within the computing system 1300 are interconnected using high-speed communication interfaces like NVLinks, enabling rapid data transfer between them, which is crucial for handling large-scale AI models and datasets with low latency. This computing system 1300 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1308, the computing system 1300 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1308 for their specific applications. The computing system 1300 is ideally suited for large-scale AI model training, real-time inference, scientific simulations, data analytics, and other compute-intensive tasks that require massive parallel processing power.

The tensor core GPUs 1308 can be coupled to multiple CPUs, such as CPU 1302 and CPU 1304, using switches 1306 (e.g., CX7 HCA/NIC with PCIe switch). The tensor core GPUs 1308 can be coupled to each other via switches 1310 (e.g., NVSwitches). The switches 1306 and switches 1310 can be coupled to high-speed transceiver modules 1312. The high-speed transceiver modules 1312 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1300 remains capable of meeting increasing data demands and can be upgraded to support future advancements in network speeds, thus contributing to the system's overall performance and scalability.

In at least one embodiment, the computing system 1300 can be considered a data-network configuration with full-bandwidth intra-server NVLinks. In this example, all eight tensor core GPUs 1308 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1308 can half-subscribe eighteen NVLinks to GPUs in other servers. Four tensor core GPUs 1308 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1308 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1300 can include the various embodiments described herein with respect to FIG. 1 to FIG. 12.

In at least one embodiment, the computing system 1300 is used for high-speed network communication and includes a processing unit (e.g., CPU 1302, CPU 1304, switches 1306, tensor core GPUs 1308, switches 1310, high-speed transceiver modules 1312), and a network interface coupled to the processing unit. The network interface can include the operations and functionality of the DPUs described herein.

In at least one embodiment, the computing system 1300 includes a host device and an auxiliary device. The auxiliary device includes a device memory and a processor, communicably coupled to the device memory. The auxiliary device performs the operations described herein with respect to FIG. 1 to FIG. 12. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors-for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A data processing unit (DPU) comprising:
DPU hardware comprising a processing device and an acceleration hardware engine; and
a memory operatively coupled to the DPU hardware, the memory to store instructions that, when executed by the DPU hardware, are to provide a virtual bridge and a network pipeline abstraction layer (NPAL) that supports multiple network protocols and network functions in a network pipeline, wherein the network pipeline comprises a set of tables and logic organized in a specific order to be accelerated by the acceleration hardware engine, wherein the virtual bridge is to:
asynchronously receive, from a first thread of the NPAL, one or more create requests to create an Equal-Cost Multi-Path (ECMP) group;
asynchronously create the respective ECMP group in response to each of the one or more create requests;
receive, from a second thread of the NPAL, a first request for acknowledgement for the one or more create requests;
determine that each of the one or more ECMP groups has been successfully created; and
send, to the second thread, a first acknowledgement in response to the first request for acknowledgement, the first acknowledgement indicating the one or more ECMP groups have been successfully created in the virtual bridge.

2. The DPU of claim 1, wherein the virtual bridge is further to:
asynchronously receive, from the first thread, one or more delete requests to delete an ECMP group;
asynchronously delete the respective ECMP group in response to each of the one or more delete requests;
receive, from the second thread, a second request for acknowledgement for the one or more delete requests;
determine that each of the one or more ECMP groups has been successfully deleted;
send, to the second thread, a second acknowledgement in response to the second request for acknowledgement, the second acknowledgement indicating the one or more ECMP groups have been successfully deleted; and
perform a second ECMP operation using at least one ECMP group.

3. The DPU of claim 1, wherein the virtual bridge is further to:
asynchronously receive, from the first thread, one or more additional create requests to create an additional ECMP group;
receive, from the second thread, a second request for acknowledgement for the one or more additional create requests;
determine that a group creation of at least one of the additional ECMP groups has failed; and
send, to the first thread, a notification indicating the group creation has failed.

4. The DPU of claim 1, wherein:
the virtual bridge is to:
monitor a link availability of each of a plurality of links to a destination, the plurality of links being specified in an initial group of identifiers of an ECMP group; and
detect a link failure of a first link of the plurality of links;
the NPAL is to:
remove a first link identifier, associated with the first link, from the initial group of link identifiers to obtain a modified group of link identifiers; and
cause a routing table in the NPAL to be updated to remove the first link identifier; and
the acceleration hardware engine is to process network traffic data using the network pipeline and distribute the network traffic data to only the remaining links of the plurality of links corresponding to the modified group of identifiers.

5. The DPU of claim 4, wherein the NPAL comprises Equal-Cost Multi-Path (ECMP) logic, wherein the ECMP logic is to:
receive a first packet prior to the link failure of the first link;
perform an Internet Protocol (IP) address lookup for the first packet to identify an ECMP group identifier associated with the plurality of links;
hash the ECMP group identifier to identify any one of the plurality of links;
receive a second packet after the link failure of the first link;
perform an IP address lookup for the second packet to identify the ECMP group identifier; and
hash the ECMP group identifier to identify any one of the remaining links.

6. The DPU of claim 4, wherein the virtual bridge is further to:
monitor the link availability of each of the plurality of links to the destination;
detect a link recovery of the first link;
add the first link identifier to the modified group of link identifiers to obtain the initial group of link identifiers; and
cause the routing table in the NPAL to be updated to add the first link identifier, and wherein the acceleration hardware engine is to process subsequent network traffic data using the network pipeline and distribute the subsequent network traffic data to the plurality of links corresponding to the initial group of identifiers.

7. The DPU of claim 6, wherein the NPAL comprises Equal-Cost Multi-Path (ECMP) logic, wherein the ECMP logic is to:
receive a first packet prior to the link recovery of the first link;
perform an Internet Protocol (IP) address lookup for the first packet to identify an ECMP group identifier associated with the plurality of links;
hash the ECMP group identifier to identify any one of the remaining links;
receive a second packet after the link recovery of the first link;
perform an IP address lookup for the second packet to identify the ECMP group identifier; and
hash the ECMP group identifier to identify any one of the plurality of links.

8. The DPU of claim 6, wherein the virtual bridge is controlled by the NPAL, wherein the virtual bridge is to:
send a first notification to the NPAL of the link failure of the first link, the NPAL to update the routing table in response to the first notification, the routing table storing configuration information associated with the initial group of identifiers; and
send a second notification to the NPAL of the link recovery of the first link, the NPAL to update the routing table in response to the second notification.

9. A computing system comprising:
a host device; and
an integrated circuit coupled to the host device and a network, wherein the integrated circuit comprises:
a network interconnect coupled to the network;
a host interconnect coupled to the host device;
an acceleration hardware engine; and
a memory to store instructions that, when executed by the integrated circuit, are to provide a virtual bridge and a network pipeline abstraction layer (NPAL) that supports multiple network protocols and network functions in a network pipeline, wherein the network pipeline comprises a set of tables and logic organized in a specific order to be accelerated by the acceleration hardware engine, wherein the virtual bridge is to:
asynchronously receive, from a first thread of the NPAL, one or more create requests to create an Equal-Cost Multi-Path (ECMP) group;
asynchronously create the respective ECMP group in response to each of the one or more create requests;
receive, from a second thread of the NPAL, a first request for acknowledgement for the one or more create requests;
determine that each of the one or more ECMP groups has been successfully created; and
send, to the second thread, a first acknowledgement in response to the first request for acknowledgement, the first acknowledgement indicating the one or more ECMP groups have been successfully created in the virtual bridge.

10. The computing system of claim 9, wherein the integrated circuit is at least one of a data processing unit (DPU), a network interface card (NIC), a network interface device, or a switch, wherein the DPU is a programmable data center infrastructure on a chip.

11. The computing system of claim 9, wherein the NPAL comprises a set of applications programming interfaces (APIs) or classes that provide a unified interface to one or more applications executed by the integrated circuit or a host device coupled to the integrated circuit.

12. The computing system of claim 9, wherein the virtual bridge is further to:
asynchronously receive, from the first thread, one or more delete requests to delete an ECMP group;
asynchronously delete the respective ECMP group in response to each of the one or more delete requests;
receive, from the second thread, a second request for acknowledgement for the one or more delete requests;
determine that each of the one or more ECMP groups has been successfully deleted; and
send, to the second thread, a second acknowledgement in response to the second request for acknowledgement, the second acknowledgement indicating the one or more ECMP groups have been successfully deleted.

13. The computing system of claim 9, wherein the virtual bridge is further to:
asynchronously receive, from the first thread, one or more additional create requests to create an additional ECMP group;
receive, from the second thread, a second request for acknowledgement for the one or more additional create requests;
determine that a group creation of at least one of the additional ECMP groups has failed; and
send, to the first thread, a notification indicating the group creation has failed.

14. A method of operating a data processing unit (DPU), the method comprising:
executing one or more instructions of a virtual bridge and a network pipeline abstraction layer (NPAL) that supports multiple network protocols and network functions in a network pipeline, wherein the network pipeline comprises a set of tables and logic organized in a specific order to be accelerated by an acceleration hardware engine;
asynchronously receiving, at the virtual bridge from a first thread of the NPAL, one or more create requests to create an Equal-Cost Multi-Path (ECMP) group;
asynchronously creating the respective ECMP group using the virtual bridge in response to each of the one or more create requests;
receiving, at the virtual bridge from a second thread of the NPAL, a first request for acknowledgement for the one or more create requests;
determining, using the virtual bridge, that each of the one or more ECMP groups has been successfully created; and
sending, to the second thread from the virtual bridge, a first acknowledgement in response to the first request for acknowledgement, the first acknowledgement indicating the one or more ECMP groups have been successfully created in the virtual bridge.

15. The method of claim 14, further comprising:
asynchronously receiving, at the virtual bridge from the first thread, one or more delete requests to delete an ECMP group;
asynchronously deleting the respective ECMP group using the virtual bridge in response to each of the one or more delete requests;
receiving, at the virtual bridge from the second thread, a second request for acknowledgement for the one or more delete requests;
determining that each of the one or more ECMP groups has been successfully deleted; and
sending, to the second thread from the virtual bridge, a second acknowledgement in response to the second request for acknowledgement, the second acknowledgement indicating the one or more ECMP groups have been successfully deleted.

16. The method of claim 14, further comprising:
asynchronously receiving, at the virtual bridge from the first thread, one or more additional create requests to create an additional ECMP group;
receiving, at the virtual bridge from the second thread, a second request for acknowledgement for the one or more additional create requests;
determine, using the virtual bridge, that a group creation of at least one of the additional ECMP groups has failed; and
sending, to the first thread from the virtual bridge, a notification indicating the group creation has failed.

17. The method of claim 14, further comprising:
monitoring, using the virtual bridge, a link availability of each of a plurality of links to a destination, the plurality of links being specified in an initial group of identifiers of an ECMP group; and
detecting, using the virtual bridge, a link failure of a first link of the plurality of links; and
removing, using the NPAL, a first link identifier, associated with the first link, from the initial group of link identifiers to obtain a modified group of link identifiers;
updating, using the NPAL, a routing table to remove the first link identifier;
processing, using the acceleration hardware engine, network traffic data using the network pipeline; and
distributing the network traffic data to only the remaining links of the plurality of links corresponding to the modified group of identifiers.

18. The method of claim 17, further comprising:
receiving a first packet prior to the link failure of the first link;
performing an Internet Protocol (IP) address lookup for the first packet to identify an Equal-Cost Multi-Path (ECMP) group identifier associated with the plurality of links;
hashing the ECMP group identifier to identify any one of the remaining links;
receiving a second packet after the link failure of the first link;
performing an IP address lookup for the second packet to identify the ECMP group identifier; and
hashing the ECMP group identifier to identify any one of the plurality of links.

19. The method of claim 14, further comprising:
monitoring, using the virtual bridge, a link availability of each of the plurality of links to a destination;
detecting a link recovery of the first link;
adding, using the NPAL, the first link identifier to the modified group of link identifiers to obtain the initial group of link identifiers;
updating, using the NPAL, a routing table to add the first link identifier;
processing, using the acceleration hardware engine, subsequent network traffic data using the network pipeline; and
distributing the subsequent network traffic data to the plurality of links corresponding to the initial group of identifiers.

20. The method of claim 19, further comprising:
receiving a first packet prior to the link recovery of the first link;
performing an Internet Protocol (IP) address lookup for the first packet to identify an ECMP group identifier associated with the plurality of links;
hashing the ECMP group identifier to identify any one of the remaining links;
receiving a second packet after the link recovery of the first link;
performing an IP address lookup for the second packet to identify the ECMP group identifier; and
hashing the ECMP group identifier to identify any one of the plurality of links.
